(19) United States
(12) Patent Application Publication
(10) Pub. No.: US 2023/0300256 A1
(43) Pub. Date: Sep. 21, 2023

(54) BLOCKCHAIN NODES AND METHODS FOR FACILITATING SPECTRUM SHARING

(71) Applicant: Sony Group Corporation, Tokyo (JP)

(72) Inventors: Youping ZHAO, Beijing (CN); Yuhong HUANG, Beijing (CN); Zhong TIAN, Beijing (CN); Chen SUN, Beijing (CN)

(73) Assignee: Sony Group Corporation, Tokyo (JP)

(21) Appl. No.: 18/036,406

(22) PCT Filed: Dec. 23, 2021
(86) PCT No.: PCT/CN2021/140649

§ 371 Date: May 11, 2023

(30) Foreign Application Priority Data
Dec. 28, 2020 (CN) 202011584568.4

(51) Int. Cl. H04M 15/00; H04W 16/14; H04W 4/24; G06Q 30/0283; G06F 16/27

(52) U.S. Cl. CPC H04M 15/51; H04M 15/48; H04W 16/14; H04W 4/24; G06Q 30/0283; G06F 16/27

(57) ABSTRACT

Blockchain nodes and methods for facilitating spectrum sharing are disclosed. The blockchain node is configured to: determine a spectrum price for a spectrum transaction between a service provider and a mobile network operator based on performance functions of the service provider and the mobile network operator; record spectrum transaction information based on the spectrum price in a blockchain, including: verifying back-block data of a block generated by a leader node in a blockchain network, the block recording the spectrum transaction information based on the spectrum price, the back-block data including only a part of the block; and adding the block generated by the leader node into the blockchain in response to the back-block data passing the verification.

### CROSS REFERENCES TO RELATED APPLICATIONS

This application claims priority of Chinese patent application titled “BLOCKCHAIN NODES AND METHODS FOR FACILITATING SPECTRUM SHARING” under the application number 202011584568.4, filed on Dec. 28, 2020, which is incorporated herein by reference in its entirety.

### TECHNICAL FIELD

The present disclosure relates to a wireless communication system, and in particular, to blockchain nodes and methods for facilitating spectrum sharing in the wireless communication system.

### BACKGROUND

In a wireless communication system, with access of a large number of wireless devices, the volume of wireless communication has grown explosively. Radio spectrum resources are becoming scarce. Dynamic Spectrum Management (DSM) may fully utilize radio spectrum resources. In a case of adopting dynamic spectrum management, a mobile network operator (MNO) as a spectrum provider may conduct a spectrum transaction dynamically with a service provider (SP) as a spectrum lessee. Through the spectrum transaction, the MNO may receive the fee paid by the SP, and the SP may use spectrum resources obtained from the MNO, which may be used by the SP to provide services for users.

In dynamic spectrum management, spectrum transactions with high efficiency and high yielding are desirable. On one hand, fast spectrum transactions are desirable, so that SPs may obtain expected spectrum resources as soon as possible. On the other hand, high spectrum utilization is desirable, so that spectrum resources provided by MNOs may be transacted to the greatest extent. Moreover, high yielding is desirable, so that the overall benefits of MNOs, SPs and users are maximized. In addition, spectrum transactions are expected to possess high fairness, security, and privacy.

Unless otherwise indicated, it should not be assumed that any of the approaches described in this section qualify as prior art merely by virtue of their inclusion in this section. Likewise, unless otherwise indicated, it should not be assumed that issues identified with respect to one or more approaches are identified in any prior art on the basis of this section.

### SUMMARY OF INVENTION

The present disclosure provides blockchain nodes and methods for facilitating spectrum sharing, which may improve the efficiency and benefit of spectrum transactions, and realize fairness, security, and privacy of spectrum transactions.

One aspect of the disclosure relates to a blockchain node for facilitating spectrum sharing, the blockchain node being included in a blockchain network that is communicatively connected to service providers and mobile network operators associated with wireless network services, the blockchain node including a processing circuit, wherein the processing circuit is configured to: determine a spectrum price for a spectrum transaction between a service provider and a mobile network operator based on a performance function of the service provider and the mobile network operator; and record spectrum transaction information that is based on the spectrum price in a blockchain, including: verifying back-block data of a block that is generated by a leader node of the blockchain network, the block recording the spectrum transaction information that is based on the spectrum price, and the back-block data only including a portion of the block; and in response to the back-block data passing the verification, adding the block that is generated by the leader node to the blockchain.

Another aspect of the disclosure relates to a method for facilitating spectrum sharing, the method including performing the following operations by a blockchain node in a blockchain network communicatively connected to service providers and mobile network operators associated with wireless network services: determining a spectrum price for a spectrum transaction between a service provider and a mobile network operator based on a performance function of the service provider and the mobile network operator; and record spectrum transaction information that is based on the spectrum price in a blockchain, including: verifying back-block data of a block that is generated by a leader node of the blockchain network, the block recording the spectrum transaction information that is based on the spectrum price, and the back-block data only including a portion of the block; and in response to the back-block data passing the verification, adding the block that is generated by the leader node to the blockchain.

A further aspect of the disclosure relates to an electronic device, including at least one processor; and at least one storage device having instructions stored thereon, which, when executed by the at least one processor, cause the at least one processor to execute any method of the disclosure.

A further aspect of the disclosure relates to a non-transitory computer readable storage medium having executable instructions stored thereon, which, when executed by the processor, cause the processor to execute any method of the disclosure.

A further aspect of the disclosure relates to a computer program product including executable instructions, which, when executed by a processor, cause the processor to execute any method of the disclosure.

The above summary is provided to summarize some exemplary embodiments so as to provide a basic understanding of aspects of the subject matter described herein. Accordingly, the above features are merely exemplary and should not be construed to narrow the scope or spirit of the subject matter described herein in any way. Other features, aspects, and advantages of the subject matter described herein will become apparent from the following detailed description described in conjunction with the accompanying drawings.

### BRIEF DESCRIPTION OF THE DRAWINGS

The above and other purposes and advantages of the present disclosure will be further described below in conjunction with specific embodiments and with reference to the accompanying drawings. In the drawings, the same or corresponding technical features or components will be indicated by the same or corresponding reference numerals.

FIG. 1 illustrates a block diagram of a wireless communication system according to an embodiment;

FIG. 2 illustrates a schematic diagram of a two-tier game model according to an embodiment;

FIG. 3 illustrates a block diagram of an electronic device that may be used to implement a blockchain node according to an embodiment;

FIG. 4 illustrates a flowchart of an exemplary method that may be performed by a blockchain node according to an embodiment;

FIG. 5 illustrates a signaling flow diagram of a first gaming process according to an embodiment;

FIG. 6 illustrates a signaling flow diagram of a second gaming process according to an embodiment;

FIG. 7 illustrates a flowchart of a static game according to an embodiment of the present disclosure;

FIG. 8 illustrates a flowchart of a dynamic game according to an embodiment of the present disclosure;

FIGS. 9A-9B illustrate signaling flow diagrams of processes for recording information of spectrum transactions in a blockchain in the form of blocks according to embodiments;

FIG. 9C illustrates a flowchart of a process for determining a leader node and/or a candidate node according to an embodiment;

FIG. 10 is a block diagram illustrating a first example of a schematic configuration of a gNB to which the technology of the present disclosure may be applied;

FIG. 11 is a block diagram illustrating a second example of a schematic configuration of a gNB to which the technology of the present disclosure may be applied;

FIG. 12 is a block diagram illustrating an example of a schematic configuration of a communication device to which the technology of the present disclosure may be applied; and

FIG. 13 is a block diagram illustrating an example of a schematic configuration of a car navigation device to which the technology of the present disclosure may be applied.

While the embodiments described in this disclosure may be susceptible to various modifications and alternative forms, specific embodiments thereof are shown by way of example in the drawings and described in detail herein. It should be understood, however, that the drawings and detailed description thereto are not to limit the embodiments to the particular forms disclosed, but on the contrary, the intention is to cover all modifications, equivalents and alternatives falling within the spirit and scope of the claims.

### DETAILED DESCRIPTION

Exemplary embodiments of the present disclosure will be described below with reference to the accompanying drawings. For clarity and conciseness, not all features of the embodiments are described in the specification. It should be understood, however, that many implementation-specific settings must be made in the process of implementing an embodiment in order to achieve specific goals of a developer, for example, to comply with those constraints related to devices and businesses, and that these constraints may vary from implementation to implementation. Moreover, it should also be understood that, development work, while potentially complex and time-consuming, is merely a routine task for those skilled in the art benefit from this disclosure.

Furthermore, in order to avoid obscuring the present disclosure with unnecessary details, only processing steps and/or device structures closely related to at least the solution according to the present disclosure are shown in the drawings, while other details not having a significant relationship to the present disclosure are omitted. It should also be noted that like reference numerals and letters indicate like items in the drawings, and thus once one item is defined in one drawings, it need not to be discussed for subsequent drawings.

In the present disclosure, the terms “first”, “second”, etc. are only used to distinguish elements or steps, and are not intended to indicate chronological order, preference or importance.

In current spectrum resource management, mobile network operators (MNOs) usually pre-allocate spectrum resources for service providers (SPs) in advance. SPs provide services to users based on the pre-allocated spectrum resources. The allocated spectral resources remain substantially unchanged (i.e., static) during communications. However, during use, users' selection of various services provided by the SPs may change, or the SPs may change types of services they provided. These may cause spectrum resources that were pre-allocated to certain SPs to fail to meet user needs, while spectrum resources that were pre-allocated to other SPs are in an idle state, resulting in waste of spectrum resources.

In order to use spectrum resources efficiently, the spectrum resources may be managed dynamically, so that multiple SPs may dynamically share the spectrum resources provided by the MNOs. For example, the MNOs may identify spectrum resources that are currently idle in the system as tradable idle spectrum resources. When users' selection of various services provided by the SPs changes, or when the SPs change types of service they provided, the SPs may update their own spectrum needs. Spectrum transactions may be performed based on the idle spectrum resources as well as the updated spectrum needs, so that the idle spectrum resources may be allocated to meet the needs of the SPs. In this way, the resulting allocation of spectrum resources is not a preset static allocation, but may dynamically change according to the needs of the users or the SPs. As a result, unlicensed SPs and/or users may opportunistically use idle spectrum resources, thereby improving the utilization of spectrum resources.

The present disclosure provides to implement spectrum resource management in a wireless communication system by using blockchain technology. In particular, by using blockchain technology, it is possible to achieve spectrum transactions with high efficiency and high yielding, and to ensure the fairness, security, and privacy of spectrum transactions, thereby facilitating dynamic spectrum management in wireless communication systems.

Blockchain technology, as an emerging technology, is essentially a digital distributed ledger. Blockchain technology includes an architecture composed of a series of algorithms, technologies, and tool sets, which guarantee the integrity, irrefutability, and non-repudiation of recorded transactions in a distributed, tamper-proof, and credible manner. As transactions progress, blocks in the blockchain continue increasing. When a new block is generated based on a transaction, each blockchain node in the blockchain network will participate in the consensus verification of the new block. If verified, the new block may be added to the blockchain. This approach ensures that each distributed blockchain node may maintain a consistent and tamper-proof distributed ledger without a central manager. In this disclosure, the term “blockchain technology” includes, but is not limited to, technologies such as distributed storage, peer-to-peer networks, consensus mechanisms, and encryption algorithms and the like.

With the characteristics of blockchain technology, improved dynamic spectrum management may be achieved. Blockchain may record spectrum sharing in wireless communication systems in a distributed manner. The blockchain may ensure that all participants in a spectrum transaction to perform specified spectrum transaction rules. When a block that is generated based on a spectrum transaction is added to the blockchain, it means that all parties participated in the spectrum transaction have reached a consensus. This resolves contention for wireless channels by multiple spectrum demanders. In addition, blockchain technology may also help overcome security challenges and enhance trust among multiple entities (such as multiple SPs) sharing spectrum resources. Since all participants may supervise related information and records cannot be tampered with or be deleted, the sharing process of spectrum resources and the value transfer process are transparent and fair. In addition, a blockchain-based trading platform may serve as an intermediate layer to isolate various participants in spectrum transactions, thereby ensuring privacy of the spectrum transactions. Moreover, the trading platform may apply a series of models to spectrum transactions, and may provide a cooperation mechanism for spectrum transactions. This may facilitate achieving of an optimal spectrum price for spectrum transactions, thereby maximizing the benefits of spectrum transactions. In addition, with improvements to the consensus verification mechanism for blockchain nodes, the efficiency of spectrum transactions may also be improved.

### 1. SYSTEM OVERVIEW

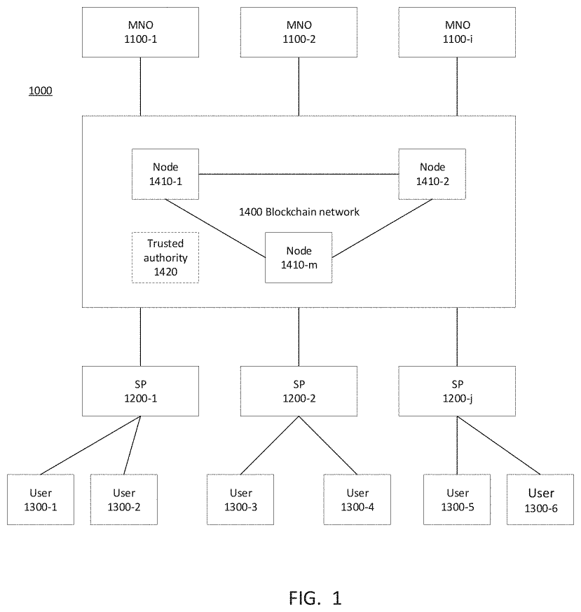

FIG. 1 illustrates a block diagram of a wireless communication system 1000 according to an embodiment. Wireless communication system 1000 may include any of various wireless communication systems, including, but not limited to, a cellular communication system, a Wi-Fi system, a Bluetooth communication system, or any system capable of communicating by means of radio technology. As a preferred example, wireless communication system 1000 may be a 5G or a 6G cellular communication system.

According to an embodiment, as shown, wireless communication system 1000 may include one or more mobile network operators (MNOs) 1100, one or more service providers (SPs) 1200, one or more users 1300, and a blockchain network 1400. It should be understood that MNO 1100 is only used to collectively refer to MNO 1100-1, MNO 1100-2, . . . , MNO 1100-i in FIG. 1. FIG. 1 is not intended to limit the specific number of MNOs. The same applies to SP 1200, user 1300 and node 1410 as well.

According to an embodiment, MNO 1100 may be a seller/lessor of spectrum resources. MNO 1100 may represent an electronic device used by the MNO. For example, the electronic device may be a control device of the MNO or may be a base station. The term “spectrum resources” in the present disclosure refers to frequency bands that may be used by user 1300 of wireless communication system 1000 to perform wireless communication. Depending on the specific type and specification of wireless communication system 1000, the frequency bands used by user 1300 to perform wireless communication may vary. Each MNO 1100 in wireless communication system 1000 may have respective spectrum resources. Each MNO 1100 may sell/lease part or all of the spectrum resources to one or more SPs, so that these SPs may use the acquired spectrum resources to provide services to users. As an example, MNO 1100 may be an infrastructure provider (e.g., China Mobile or China Unicom).

According to an embodiment, SP 1200 may be a purchaser/lessee of spectrum resources. SP 1200 may represent an electronic device used by the SP. For example, the electronic device may be a control device of the SP. Each SP 1200 may obtain spectrum resources from one or more MNOs 1100 through spectrum transactions. A “spectrum transaction” in the disclosure may refer to a process in which SP 1200 obtains from MNO 1100 at least the right to use part or all of the MNO's spectrum resources by paying a fee (or any other compensation). SP 1200 may provide one or more types of services to one or more users 1300 by using spectrum resources obtained through spectrum transactions. Services provided by SP 1200 include, but are not limited to, a cellular telephone service, a VoIP service, an Internet service, a television service, a streaming service, and the like. Different SPs 1200 (for example, SP 1200-1 and SP 1200-2) may provide respective services. These services may occupy different spectrum resources and may have different prices. In addition, a single SP 1200 may provide many different services. These services may occupy different spectrum resources and have different prices. As an example, SP 1200 may be a mobile virtual network operator, which may obtain spectrum resources from an infrastructure provider to provide services to users.

According to an embodiment, user 1300 may represent any individual or organization that uses services provided by the SP 1200. For example, user 1300 may be represented as various terminal devices, including but not limited to smart phones, computers, servers, industrial devices, wearable devices, televisions, and the like. User 1300 may select one or more services from various services provided by one or more SPs based on its own communication needs and the types and prices of services provided by the SPs. Accordingly, user 1300 needs to pay a fee (or any other compensation) to respective SP 1200 for each service the user selected. In the example of FIG. 1, each user 1300 is shown connected to only a single SP 1200, for simplicity. However, it may be understood that in other examples, each user 1300 may be connected to one or more SPs 1200. User 1300 may use services provided by each of the one or more SPs 1200.

According to an embodiment, blockchain network 1400 may act as a blockchain trading platform. The blockchain trading platform may be communicatively connected to one or more MNOs and one or more SPs, and facilitate spectrum transactions between the MNOs and the SPs. As shown in FIG. 1, blockchain network 1400 may include multiple blockchain nodes 1410. The multiple blockchain nodes 1410 may jointly maintain a blockchain. The blockchain may record information of one or more spectrum transactions between the MNOs and the SPs over blockchain network 1400. Each blockchain node 1410 may store and maintain a copy of the blockchain ledger. In addition, each blockchain node 1410 may store copies of smart contracts for spectrum transactions.

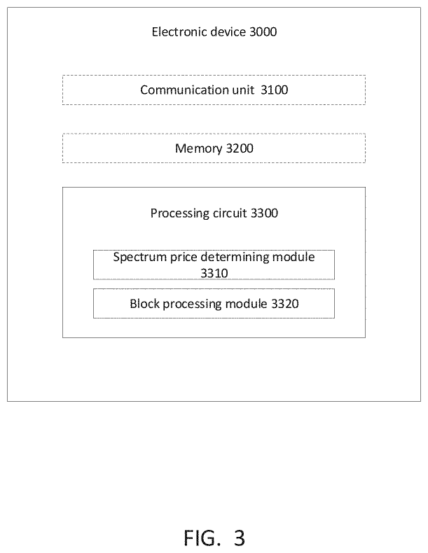

According to an embodiment, blockchain node 1410 may be implemented on or as an electronic device. The term “electronic device” refers to any hardware device that includes a processor. FIG. 3 illustrates a block diagram of an electronic device that may be used to implement blockchain node 1410. Each blockchain node 1410 may communicate with one or more other blockchain nodes, one or more MNOs 1100, or one or more SPs 1200 via wired or wireless connections. Examples of wired connections include, but are not limited to, Ethernet connections and cable connections, and examples of wireless connections include, but are not limited to, cellular connections, Wi-Fi connections, Bluetooth connections, and the like.

According to a preferred embodiment of the present disclosure as shown in FIG. 1, blockchain node 1410 may be implemented as an independent electronic device that is separated from MNO 1100 or SP 1200. In this case, MNO 1100 and SP 1200 are isolated during a spectrum transaction process, so that participants in the spectrum transaction do not contact each other directly, thereby ensuring privacy of the spectrum transaction.

According to other embodiments of the present disclosure, each blockchain node 1410 may be integrated with MNO 1100 or SP 1200. For example, each blockchain node 1410 may be implemented as an electronic device of respective MNO 1100 or as a part thereof. Alternatively, each blockchain node 1410 may be implemented as an electronic device of respective SP 1200 or as a part thereof. In this case, existing electronic devices of MNO 1100 or SP 1200 may act as blockchain nodes, thereby reducing the cost of constructing blockchain network 1400 and saving communication overhead.

According to an optional embodiment of the present disclosure, blockchain network 1400 may also include a trusted authority 1420. Trusted authority 1420 may be used to manage and verify identities of the parties involved in spectrum transactions. For example, MNOs and/or SPs may register with trusted authority 1420 to obtain certificates and/or respective public and private keys, etc. to prove their legal identity. The obtained certificates, public and/or private keys may be used to enhance security in spectrum transactions.

It may be understood that wireless communication system 1000 shown in FIG. 1 is only exemplary and not restrictive. In other embodiments, wireless communication system 1000 may include more or fewer components, and the components may be connected in different manners without departing from the scope of the present disclosure.

### 2. TWO-TIER GAME MODEL

According to an embodiment, in a multi-user-multi-SP-multi-MNO system (for example, wireless communication system 1000 in FIG. 1), in order to maximize the benefits of spectrum transactions, a two-tier game model may be used to determine information associated with the spectrum transactions, these information including but not limited to spectrum prices, spectrum demand amounts, selections of services, etc. Since all parties involved in the game aim at maximizing their own benefits, a two-tier game model 2000, as a layered game framework, may solve the interactive decision-making issue effectively.

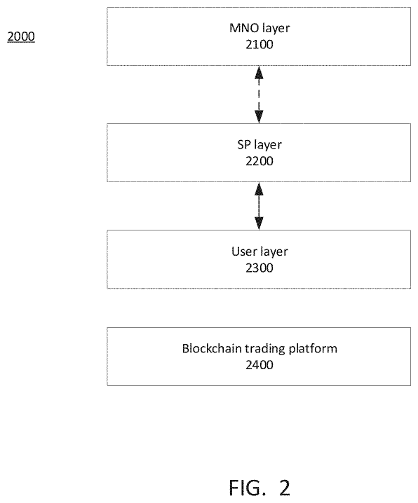

FIG. 2 illustrates a schematic diagram of a two-tier game model 2000 according to an embodiment. The two-tier game model 2000 may include an MNO layer 2100, an SP layer 2200, a user layer 2300 and a blockchain trading platform 2400. As an example, MNO layer 2100 may include one or more MNOs 1100, SP layer 2200 may include one or more SPs 1200, user layer 2300 may include one or more users 1300, and blockchain trading platform 2400 may include blockchain network 1400.

The two-tier game model 2000 may include a first gaming process between SP layer 2200 and user layer 2300, and a second gaming process between MNO layer 2100 and SP layer 2200. The first gaming process may be used to determine the price of a service of each SP and/or spectrum demand amount of each SP. The second gaming process may be used at least to determine spectrum prices of spectrum transactions between the MNOs and the SPs and/or spectrum demand amount of each SP. The spectrum demand amount herein may be represented, for example, as the amount of spectrum resources (for example, 3 MHz) required by the SP to provide one or more services. The spectrum price herein may be represented, for example, as the price per unit frequency band (e.g., 1 MHz).

According to an embodiment, the two-tier game model 2000 may adopt a static game. Preferably, the two-tier game model 2000 may adopt a dynamic game. Where a dynamic game is adopted, each of the first gaming process and the second gaming process may be modeled as a Stackelberg game. The basic idea of the Stackelberg game is that both parties participating in the game choose their own strategy according to the other party's possible strategy, so as to ensure their own benefit is maximized under the other party's strategy. In this game model, the party that makes the decision first is called a leader. Subsequent to the leader, the remaining participants make decisions based on the leader's decision, and these participants are called followers. The leader then adjusts its own decision based on the followers' decisions. This is repeated until a Nash equilibrium is reached. The leader may predict decisions of the followers. Specific embodiments of static game and dynamic game will be further described below.

According to an embodiment, the second gaming process between MNO layer 2100 and SP layer 2200 may be performed through blockchain trading platform 2400. Blockchain trading platform 2400 may collect information of each MNO and each SP. And the optimal spectrum price may be determined by blockchain nodes based on these information, so as to maximize the overall benefits of a spectrum transaction. In the second gaming process, MNOs and SPs as participants do not need to contact directly, but to forward information through the blockchain nodes. This may protect privacy, especially if multiple SPs and multiple MNOs are all involved in the transaction. In FIG. 2, interactions between MNO layer 2100 and SP layer 2200 is shown as dashed arrows to indicate that these interactions are indirect.

Specific embodiments of the first gaming process and the second gaming process will be further described below.

### 3. EXEMPLARY ELECTRONIC DEVICE FOR IMPLEMENTING BLOCKCHAIN NODES

FIG. 3 illustrates a block diagram of an electronic device 3000 that may be used to implement a blockchain node 1410 according to an embodiment. According to one embodiment, electronic device 3000 may be located at the MNO or the SP. According to a preferred embodiment, electronic device 3000 may be an independent electronic device that is separated from the MNO and the SP. Electronic device 3000 may include a communication unit 3100, a memory 3200 and a processing circuit 3300.

Communication unit 3100 may act as a communication interface of electronic device 3000. Communication unit 3100 may be configured to receive data sent by the MNO, SP, and/or other blockchain nodes, and provide the data to other parts of electronic device 3000 (e.g., processing circuit 3300 or memory 3200). Communication unit 3100 may further be configured to send data from electronic device 3000 to the MNO, SP, and/or other blockchain nodes. The data sent by communication unit 3100 may come from other parts of electronic device 3000 (e.g., processing circuit 3300 or memory 3200). Data received or sent by communication unit 3100 may include information associated with spectrum transactions. The information may include information associated with spectrum pricing processes, such as spectrum demand amount of the SP, the spectrum quotation of the MNO, the performance functions of the MNO/SP, and the like. The information may also include information associated with the blockchain, such as information regarding generation and verification of blocks associated with spectrum transactions. Communication unit 3100 may be adapted to wired communication or wireless communication and may use various communication protocols without limitation. In FIG. 3, communication unit 3100 is drawn with dashed lines, since it may also be located within processing circuit 3300 or external to electronic device 3000.

Memory 3200 may act as a storage of electronic device 3000. Memory 3200 may be configured to store information generated by processing circuit 3300, data received or sent through communication unit 3100, instructions for operations of electronic device 3000, programs, machine codes and data, and the like. For example, memory 3200 may store the information associated with spectrum transactions sent or received by communication unit 3100 as described above. Additionally, memory 3200 may store a copy of a blockchain ledger as well as copies of smart contracts. The blockchain ledger may include a log of executed spectrum transactions and/or states associated with participants after the execution of the spectrum transactions. A smart contract may be implemented as a collection of digitalized codes, which represents business rules (or contract terms) jointly formulated by participants involved in spectrum transactions. Memory 3200 may include one or more volatile memories and/or nonvolatile memories. For example, memory 3200 may include, but is not limited to, a random access memory (RAM), a dynamic random access memory (DRAM), a static random access memory (SRAM), a read only memory (ROM), and a flash memory. In FIG. 3, memory 3200 is drawn with dashed lines, since it may also be located within processing circuit 3300 or external to electronic device 3000.

Processing circuit 3300 may be configured to provide various functions of electronic device 3000. According to an embodiment, processing circuit 3300 may be configured to determine spectrum prices for spectrum transactions between SPs and MNOs, and record information of the spectrum transactions based on the spectrum prices in a blockchain. To this end, processing circuit 3300 may include a spectrum price determining module 3310 and a block processing module 3320.

According to an embodiment, spectrum price determining module 3310 may be configured to determine the spectrum price. Spectrum price determining module 3310 may determine the spectrum price based on information related to SPs and MNOs (for example, spectrum demand amounts, spectrum quotations, etc.). For example, spectrum price determining module 3310 may be configured to determine a spectrum price for a spectrum transaction between a SP and a MNO based on performance functions of the SP and the MNO. A performance function is a function used to measure benefits (or in other words, performances) of participants associated with a spectrum transaction. The determined spectrum price may be used by the SP and the MNO to execute the spectrum transaction.

According to an embodiment, block processing module 3320 may be configured to record information of a spectrum transaction based on the determined spectrum price in a blockchain. To this end, block processing module 3320 may be configured to verify a block that is generated by a leader node of the blockchain network. The block generated by the leader node may record the information of the spectrum transaction based on the determined spectrum price. Preferably, block processing module 3320 may be configured to verify only back-block data in the block, and the back-block data may only include a part of the block instead of all of it. Block processing module 3320 may be configured to add the block generated by the leader node to the blockchain in response to the back-block data passing the verification.

According to an embodiment, spectrum price determining module 3310 may be configured to determine the spectrum price based on the performance function by following operations: receiving spectrum demand information of the SP; receiving spectrum quotation information of the MNO; calculating performance of the SP or the MNO using the performance function based on the spectrum demand information and the spectrum quotation information; determining whether the performance satisfies a Nash equilibrium condition based on a Stackelberg gaming process; and determining the spectrum price for the spectrum transaction in response to the performance satisfying the Nash equilibrium condition. In response to the performance not satisfying the Nash equilibrium condition, spectrum price determining module 3310 may be configured to: receive updated spectrum demand information of the SP and updated spectrum quotation information of the MNO; and calculate updated performance of the SP or the MNO based on the updated spectrum demand information and the updated spectrum quotation information. Spectrum price determining module 3310 may be further configured to determine whether the updated performance satisfies the Nash equilibrium condition.

According to an embodiment, spectrum price determining module 3310 may be configured to calculate the performance function of the SP based at least on income of the SP. In addition to the basic income obtained by providing services to users, the income of the SP may include a first compensation income, which is, in response to detecting that the SP participating in the spectrum transaction did not obtain the spectrum, obtained by the SP from a second SP that obtained the spectrum. Preferably, the income of the SP may further include a second compensation income, which is, in response to detecting that the second SP refuses to pay the first compensation income, obtained by the SP from the second SP. The second compensation income may be considered as a penalty income earned from the second SP. In this embodiment, spectrum price determining module 3310 may be configured to receive one or more compensation coefficients from the SP. Spectrum price determining module 3310 may determine the first compensation income or the second compensation income based on the one or more compensation coefficients, so as to determine the performance function of the SP.

According to an embodiment, spectrum price determining module 3310 may be configured to calculate the performance function of the SP based at least on payout of the SP. In addition to the basic payout for purchasing spectrum resources from the MNO, the payout of the SP may include a first compensation payout, which is, in response to detecting that the SP participating in a spectrum transaction obtained the spectrum, paid by the SP to one or more other SPs that did not obtain the spectrum. Preferably, the payout of the SP may further include a second compensation payout, which is, in response to detecting that the SP has not paid the first compensation payout, paid by the SP to one or more other SPs. The second compensation payout may be considered as a penalty payout paid by this SP. In this embodiment, spectrum price determining module 3310 may be configured to receive one or more compensation coefficients from the SP. Spectrum price determining module 3310 may determine the first compensation payout or the second compensation payout based on the one or more compensation coefficients, so as to determine the performance function of the SP.

According to an embodiment, a leader node of the blockchain network may be selected as a blockchain node that generates a block earliest among all blockchain nodes of the blockchain network. Generating a block may include finding a random number that satisfies an operation threshold condition based on a hash operation. The operation threshold condition for each blockchain node in the blockchain network may be different. For example, the operation threshold condition for each blockchain node may be determined based on a coin age of the blockchain node. The coin age may be defined as the amount of virtual currency held by a blockchain node multiplied by the time the blockchain node has held the virtual currency.

According to an embodiment, a blockchain network may include candidate nodes in addition to the leader node. Block processing module 3320 may be configured to verify back-block data of blocks that are generated by a candidate node of the blockchain network in response to the back-block data of the leader node failing to pass the verification. The candidate nodes may be one or more blockchain nodes in the blockchain network that satisfy following conditions: the difference between the time when the candidate nodes generate the blocks and the time when the leader node generates the block does not exceed a predetermined time threshold, and the coin ages of the candidate nodes are less than the coin age of the leader node.

According to an embodiment, block processing module 3320 may further be configured to: add a block generated by the candidate node to the blockchain in response to back-block data of the candidate node passing the verification; and terminate to record spectrum transaction information in the blockchain in respond to the back-block data of the candidate node failing to pass the verification.

According to an embodiment, the back-block data in the block generated by each blockchain node may include the spectrum price for the spectrum transaction and the random number satisfying the operation threshold condition of the blockchain node, excluding identity information of the transaction participants of the spectrum transaction.

According to an embodiment, spectrum transactions between the MNOs and the SPs may be executed through smart contracts running on the blockchain nodes. A smart contract is a contract clause jointly formulated by users (such as the MNOs, the SPs) of the blockchain trading platform. By formulating the smart contracts, a spectrum sharing scheme is encoded into an agreement executed in digital form, which stipulates rights and obligations of participants in spectrum transactions. The smart contract may be enforced automatically. For example, when a spectrum transaction is reached, the smart contract may automatically transfer an amount of virtual digital currency based on the spectrum price from the SP's digital wallet to a respective MNO's digital wallet.

It should be noted that, although various units of electronic device 3000 are shown as discrete units in FIG. 3, one or more of these units may also be combined into one unit, or split into multiple subunits. Functions or operations of each unit are not limited to those described above. Functions or operations described further below may also be implemented by corresponding units of electronic device 3000.

### 4. EXEMPLARY METHODS FOR BLOCKCHAIN NODES

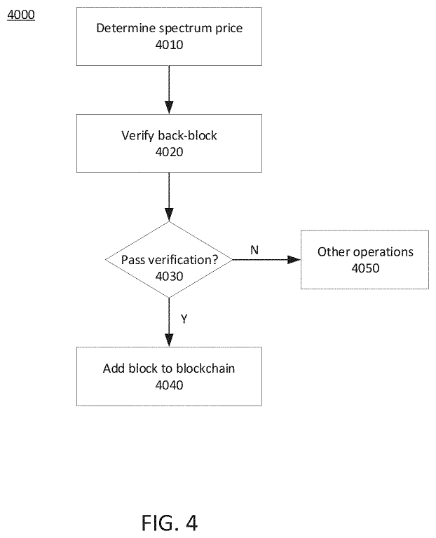

FIG. 4 illustrates a flowchart of an exemplary method 4000 that may be performed by a blockchain node, according to an embodiment. As an example, method 4000 may be performed by blockchain node 1410. Specifically, method 4000 may be executed by processing circuit 3300 of electronic device 3000.

Method 4000 may start with step 4010. In step 4010, blockchain node 1410 may determine a spectrum price. Specifically, blockchain node 1410 may determine the spectrum price for a spectrum transaction between SPs and a MNOs based on performance functions of the SPs and the MNOs.

Subsequently, method 4000 may proceed to step 4020. In step 4020, blockchain node 1410 may verify back-block data of a block generated by a leader node of a blockchain network. This block records information of the spectrum transaction based on the determined spectrum price. The back-block data includes only a part of the block.

Subsequently, method 4000 may proceed to step 4030. In step 4030, blockchain node 1410 may determine whether the back-block data passes the verification.

In response to the back-block data passing the verification, in step 4040, blockchain node 1410 may add the block generated by the leader node to the blockchain.

In response to the back-block data failing to pass the verification, in step 4050, blockchain node 1410 may perform other operations, which will be further described later.

According to an embodiment, in method 4000, determining the spectrum price based on the performance functions may include: receiving spectrum demand information of a SP; receiving spectrum quotation information of a MNO; calculating performance of the SP or MNO using the performance functions based on the spectrum demand information and the spectrum quotation information; determining whether the performance satisfies a Nash equilibrium condition based on a Stackelberg gaming process; and determining the spectrum price for the spectrum transaction in response to the performance satisfying the Nash equilibrium condition.

According to an embodiment, method 4000 may further include: in response to the performance not satisfying the Nash equilibrium condition, receiving updated spectrum demand information of the SP and updated spectrum quotation information of the MNO; and calculating updated performance of the SP or the MNO based on the updated spectrum demand information and the updated spectrum quotation information.

According to an embodiment, method 4000 may include calculating the performance function of the SP based at least on the income of the SP, the income of the SP including at least one of: a first compensation income, which is, in response to detecting that the SP participating in the spectrum transaction did not obtain the spectrum, obtained by the SP from a second SP that obtained the spectrum; or a second compensation income, which is, in response to detecting that the second SP refuses to pay the first compensation income, obtained by the SP from the second SP.

According to an embodiment, in method 4000, calculating the performance function of the SP may include: receiving one or more compensation coefficients from the SP; and determining the first compensation income or the second compensation income based on the one or more compensation coefficients.

According to an embodiment, method 4000 may include calculating the performance function of the SP based at least on the payout of the SP, the payout of the SP including at least one of: a first compensation payout, which is, in response to detecting that the SP participating in the spectrum transaction obtains the spectrum, paid by the SP to one or more other SPs that did not obtain the spectrum; or a second compensation payout, which is, in response to detecting that the SP has not paid the first compensation payout, paid by the SP to the one or more other SPs.

According to an embodiment, in method 4000, the leader node may be selected as a node that generates a block earliest among all nodes of the blockchain network.

According to an embodiment, in method 4000, generating a block may include finding a random number satisfying an operation threshold condition based on a hash operation, wherein the operation threshold condition for each node may be determined based on a coin age of the node.

According to an embodiment, method 4000 may further include: verifying back-block data of a block that is generated by a candidate node of the blockchain network in response to the back-block data of the leader node failing to pass the verification. The candidate node may be a node in the blockchain network that meet following conditions: a difference between the time when the candidate node generates the block and the time when the leader node generates the block does not exceed a predetermined time threshold, and the coin age of the candidate node is less than the coin age of the leader node.

According to an embodiment, method 4000 may further include: adding the block generated by the candidate node to the blockchain in response to the back-block data of the candidate node passing the verification; and terminating to record spectrum transaction information in the blockchain in respond to the back-block data of the candidate node failing to pass the verification.

According to an embodiment, in method 4000, back-block data may include the spectrum price and the random number satisfying the operation threshold condition, but not include identity information of traders in the spectrum transaction.

It should be noted that, although FIG. 4 describes various steps of method 4000 in a sequential manner, one or more of these steps may also be combined into one step, or split into multiple sub-steps. These steps may be performed in a different order, or may be performed in parallel. Methods performed by blockchain nodes may also include one or more additional operations described herein.

### 5. GAMING PROCESS

According to an embodiment, in a multi-user-multi-SP-multi-MNO system (for example, wireless communication system 1000 in FIG. 1), various information associated with spectrum transactions, such as spectrum demand amounts, spectrum prices, prices of services of SPs, etc., may be determined through a two-tier game model. The two-tier game model 2000 may include a first gaming process between SPs and users, and a second gaming process between MNOs and SPs. This section will describe example embodiments of the first gaming process and the second gaming process, respectively.

### 5-1. The First Gaming Process

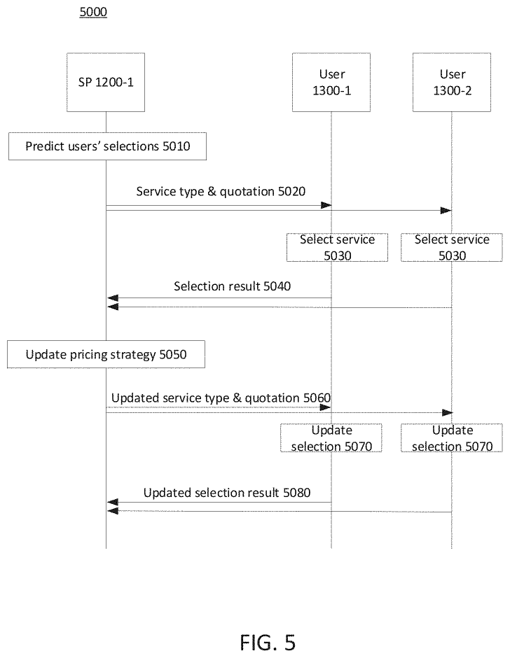

FIG. 5 illustrates a signaling flow diagram of a first gaming process 5000 according to an embodiment. For simplicity, FIG. 5 illustrates interactions between a single SP 1200-1 and two users 1300-1 and 1300-2. It may be understood that the first gaming processes of other SPs 1200 are similar. Also, each SP 1200 may game with more users.

According to an embodiment, the first gaming process 5000 may be a Stackelberg game. During the first gaming process, SP 1200-1 may be a leader, while users 1300-1 and 1300-2 may be followers.

Considering that the number of users is very large, it may be considered that a choice of a single user has no significant impact on the decision of the SP. Therefore, in the first gaming process, service selection behavior of users may be modeled in accordance with proportions of users (instead of user by user). This helps reduce computational overhead in a case that the total number of users is very large.

First gaming process 5000 may start with step 5010. In step 5010, SP 1200-1 may predict choices of users on services provided by SP 1200-1. The prediction of SP 1200-1 may be based on matching between attributes of the users (e.g., consumption capability of the users, consumption preference of the users, etc.) and attributes of the services (e.g., type and price of the services). Preferably, SP 1200-1 may predict a proportion of users who will choose a certain service among the total users, instead of predicting a choice of individual users.

Subsequently, first gaming process 5000 may proceed to step 5020. In step 5020, SP 1200-1 may determine a quotation for each service, and broadcast a service type of each service along with the determined quotation of the service to each user 1300-1, 1300-2. The service type may indicate a category of the service (e.g., a cellular phone service or a streaming service) and service parameters (e.g., a communication rate, an available region, an available time), and the like. Preferably, the quotation for each service may be determined based on the predicted choices of the users.

Subsequently, first gaming process 5000 may proceed to step 5030. In step 5030, each user 1300-1, 1300-2 may select a corresponding SP and a respective service type. The user may select based on its own communication needs. For example, in order to obtain 5G cellular phone services, the user may select a corresponding service type. In addition, the user may select based on the quotations for the services of the SP. Usually, the user may select the service with the lowest quotation among multiple services of the same type.

Subsequently, first gaming process 5000 may proceed to step 5040. In step 5040, each user 1300-1, 1300-2 may send its selection result to SP 1200-1. The selection result may at least indicate the service type that is selected by each user.

Then, first gaming process 5000 may proceed to step 5050. In step 5050, SP 1200-1 may perform an updating step according to the received selection results of the users, and the updating step may update a strategy of SP 1200-1 for quotation. For example, SP 1200-1 may update the quotations for one or more services. The purpose of the updating step for SP 1200-1 is to maximize the benefit of SP 1200-1 (e.g., income from services), which may be calculated by the performance function of SP 1200-1.

Subsequently, the first gaming process 5000 may proceed to step 5060. In step 5060, SP 1200-1 may broadcast the updated quotation of each service to each user 1300-1, 1300-2.

Subsequently, the first gaming process 5000 may proceed to step 5070. In step 5070, each user 1300-1, 1300-2 may perform an updating step based on the updated quotation for each service, and the updating step may update the service selected by the user accordingly. The purpose of the updating step for user 1300 is to maximize the benefit of the user, which may be calculated by the performance function of the user.

In step 5080, each user 1300-1, 1300-2 may send the updated selection result to SP 1200-1. The updated selection result may indicate the service type re-selected by each user.

According to an embodiment, first gaming process 5000 may include performing steps 5050 to 5080 repeatedly. As an example, first gaming process 5000 associated with SP 1200-1 may be triggered whenever a user's selection of a service provided by SP 1200-1 changes. For example, when the change in the proportion of users who select a certain service type exceeds a threshold, the first gaming process 5000 associated with SP 1200-1 that provides the service type may be triggered. Alternatively or additionally, SP 1200-1 may actively change the quotation for the provided service, which may also trigger first gaming process 5000 associated with SP 1200-1.

According to an embodiment, SP 1200-1 may determine a spectrum demand amount of SP 1200-1. For example, SP 1200-1 may determine the spectrum demand amount based on services that are currently provided and the users' selections of the current services. Different types of services may have different spectrum demands. SP 1200-1 may calculate the spectrum demand amount for each service according to service parameters of said each service and the number/proportion of users who select the service. SP 1200-1 may calculate a total spectrum demand amount based on spectrum demand amounts of all services. This calculation may be performed after users have fed back selection results to the SP. The calculated spectrum demand amount may be used in the second gaming process.

### 5-2. The Second Gaming Process

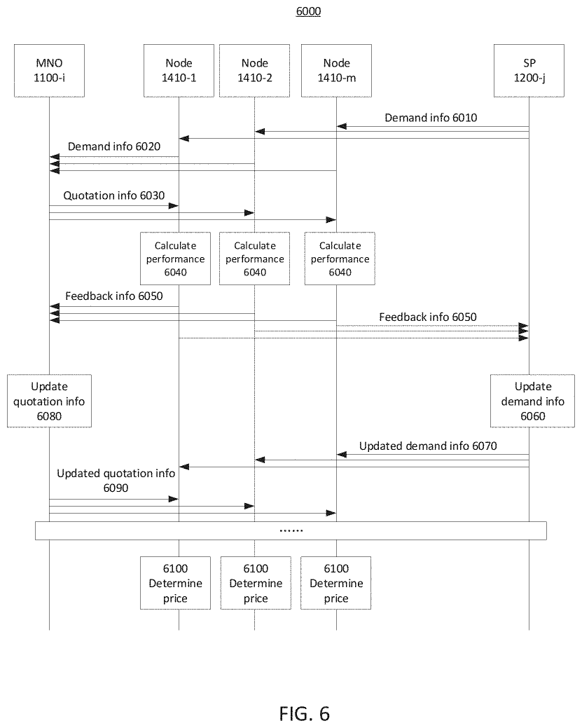

FIG. 6 illustrates a signaling flow diagram of a second gaming process 6000 according to an embodiment. For simplicity, FIG. 6 illustrates interactions between an MNO 1100-i and an SP 1200-j. It should be noted that MNO 1100-i is a general reference, which may represent one or more MNOs. Also, SP 1200-j is a general reference, which may represent one or more SPs.

According to an embodiment, second gaming process 6000 may be a Stackelberg game. During the second gaming process, MNO 1100-i may be a leader, while SP 1200-j may be a follower. That is to say, SP 1200-j may make decisions based on MNO 1100-i's decisions, and MNO 1100-i may predict SP 1200-j's decisions. During the gaming process, MNO 1100-i may make a decision first, and SP 1200-j may then make a decision based on that decision of MNO 1100-i. Then, MNO 1100-i adjusts its decision according to the decision of SP 1200-j. Repeat this until a Nash equilibrium is reached.

According to an embodiment, in second gaming process 6000, MNO 1100-i and SP 1200-j do not interact directly, but through one or more blockchain nodes 1410-1, 1410-2, . . . , 1410-m of the blockchain trading platform. This may realize isolation of the MNO and the SP.

Second gaming process 6000 may start with step 6010. In step 6010, SP 1200-j may send demand information to blockchain node 1410. The demand information may at least include a spectrum demand amount of SP 1200-j. The spectrum demand amount is, for example, determined during the first gaming process as described above. Additionally, the demand information may contain identity information for identifying SP 1200-j. According to one embodiment, SP 1200-j may send the demand information to one associated blockchain node (for example, the nearest blockchain node), and that blockchain node forwards it to other blockchain nodes. According to another embodiment, SP 1200-j may broadcast the demand information to each blockchain node of the blockchain network.

In step 6020, each blockchain node 1410 may forward the demand information received from SP 1200-j to MNO 1100-i. In one embodiment, the forwarded demand information may include the identity information of SP 1200-j. In a preferred embodiment, when forwarding the demand information, blockchain node 1410 may remove the identity information or identification information associated with SP 1200-j. For example, blockchain node 1410 may send a total spectrum demand of all SPs in the current system to MNO 1100-i, instead of forwarding demand information of a specific SP 1200-j.

In step 6030, MNO 1100-i may send quotation information to blockchain node 1410. The quotation information may include spectrum quotation of the MNO. For example, the spectrum quotation may be an quotation per unit of frequency band. This quotation is an initial spectrum quotation. In one embodiment, the initial spectrum quotation may be a default quotation. In a preferred embodiment, the initial spectrum quotation may be generated based on the spectrum demand amount and the prediction for the decisions of SP 1200-j by MNO 1100-i.

In step 6040, blockchain node 1410 may initially use one or more performance functions to calculate performance of the SP and the MNO based on the demand information and the quotation information. Specifically, blockchain node 1410 may use a performance function of MNO 1100-i to calculate the performance of MNO 1100-i, and/or use a performance function of SP 1200-j to calculate the performance of SP 1200-j. Example embodiments of performance functions of the SPs and the MNOs are described further below.

In step 6050, blockchain node 1410 may send feedback information to MNO 1100-i and SP 1200-j. According to an embodiment of the present disclosure, blockchain node 1410 may determine whether the performance calculated in step 6040 satisfies a Nash equilibrium condition, and include the determination result in the feedback information. For example, the feedback information sent to MNO 1100-i may include the determination result, and optionally also include current demand information of SP 1200-j. The feedback information sent to SP 1200-j may include the determination result, and optionally also include current quotation information of MNO 1100-i.

According to an embodiment of the present disclosure, in step 6060, in response to receiving the determination result indicating that the performance does not satisfy the Nash equilibrium condition, SP 1200-j may update its own strategy. For example, SP 1200-j may generate updated demand information. Specifically, SP 1200-j may generate the updated demand information based on current users' selections (e.g., from previous first gaming process) and received quotation information. The generated updated demand information may contain a spectrum demand amount that maximizes the value of the performance function of SP 1200-j. Optionally, SP 1200-j may initiate the first gaming process to re-determine service prices and the spectrum demand of SP 1200-j. The re-determined spectrum demand may be included in the updated demand information. In step 6070, SP 1200-j may send the generated updated demand information to blockchain node 1410.

According to an embodiment of the present disclosure, in step 6080, in response to receiving the determination result indicating that the performance does not satisfy the Nash equilibrium condition, MNO 1100-i may generate updated quotation information. The quotation information may be an adjustment to the quotation information of step 6030. For example, MNO 1100-i may increase its spectrum quotation to increase the performance of the MNO. In step 6090, MNO 1100-i may send the generated quotation information to blockchain node 1410.

Subsequently, second gaming process 6000 may return to step 6040. In this step, blockchain node 1410 may use the performance functions to calculate the performances of the SP and the MNO again based on current demand information and quotation information. Then, step 6050 may be performed to determine whether the recalculated performance satisfies the Nash equilibrium condition. As mentioned above, blockchain node 1410 may send feedback information including the determination result to MNO 1100-i and SP 1200-j. If the recalculated performance still does not satisfy the Nash equilibrium condition, steps 6060 to 6090 may be performed again, and then return to step 6040. This may iterate until the calculated performance satisfies the Nash equilibrium condition. In FIG. 6, iterations of second gaming process 6000 are represented using boxes with ellipses. In response to the performance satisfying the Nash equilibrium condition, a spectrum price for spectrum resource may be determined in step 6100. This price may be, for example, the current quotation of MNO 1100-i. The determined spectrum price may be sent to MNO 1100-i and SP 1200-j to instruct MNO 1100-i and SP 1200-j to perform the spectrum transaction according to the determined spectrum price.

The above embodiment implements a dynamic spectrum sharing scheme based on layered games based on blockchain technology. By modeling spectrum transaction processes through layered games, the interactive decision-making issue between participants in the spectrum transactions may be better solved, and the optimal spectrum sharing and pricing strategy (spectrum prices, spectrum demand amounts, etc.) may be obtained. This may maximize the benefits of the spectrum transactions and improve spectrum utilization.

### 5-3. Performance Functions

### 5-3-1. Performance Functions of MNOs

A performance function is a function used to measure benefits (or in other words, performance) of participants associated with a spectrum transaction. Each user, each SP and each MNO may have a corresponding performance function respectively. Example embodiments of performance functions of MNOs, user and SPs are given below, respectively.

According to an embodiment, the performance function of each MNO may be determined based on the MNO's income and payout. For a spectrum transaction process, the income of the MNO may include an income obtained by selling/renting spectrum resources to SPs, and the income is associated with the amount of spectrum resources traded as well as the price per unit spectrum. Payout of the MNO may include cost for maintaining spectrum resources (e.g., maintaining base stations, etc.), which is associated with the amount of spectrum resources and a construction cost coefficient per unit spectrum. The performance function of the MNO may be expressed as a difference between the income and the cost.

For example, equation (1) below gives an example embodiment of the performance function of the i-th MNO:

$${U}_{MNO}^{i} ( {p}_{i}^{o} , {b}_{j} ) = {{\sum }_{j = 1}}^{K} ( {p}_{i}^{o} {b}_{j} - {m}_{i} {b}_{j} ) \qquad ( 1 )$$

where, U_{MNO}ⁱ prepresents the performance (benefit) of the i-th MNO, pᵢ^{o} represents the quotation per unit frequency band of the spectrum of the i-th MNO, bⱼ represents the spectrum demand amount of the j-th SP, and mᵢ represents the construction cost coefficient of the i-th MNO.

Accordingly, maximizing the benefit of the MNO may be equivalent to an optimization problem of maximizing the value of the performance function of the MNO. The optimization problem may be expressed as equation (2):

$${max}_{{p}_{i}^{o} \geq 0} {U}_{M N O}^{i} ( {p}_{i}^{o} , {b}_{j} ) \qquad ( 2 )$$

$$s . t . {\sum }_{j}^{K} {b}_{j} \leq B , {p}_{i}^{o} \geq {m}_{i}$$

where, K represents the number of SPs in the system, and B represents the total amount of available frequency spectrum.

According to one embodiment, bⱼ may be determined based on the purchase strategy of the j-th SP and the number of frequency bands that may be purchased with a unit price. For example, bⱼ may be represented as bⱼ=wⱼq, where wⱼ represents the purchase strategy offered by the j-th SP, and q represents the number of frequency bands that may be purchased per unit price. In this embodiment, the performance function of the i-th MNO may be further expressed as:

$$\begin{matrix}{U}_{MNO}^{i} ( {p}_{i}^{o} , {b}_{j} ) = {\sum }_{j = 1}^{K} ( {p}_{i}^{o} {b}_{j} - {m}_{i} {b}_{j} ) \\ = {\sum }_{j = 1}^{K} ( {p}_{i}^{o} {w}_{{j}^{q}} - {m}_{i} {w}_{{j}^{q}} )\end{matrix} \qquad ( 3 )$$

### 5-3-2. Performance Functions of SPs

According to an embodiment of the present disclosure, a performance function of each SP may be determined based on the SP's income and payout. The performance function of the SP may be expressed as a difference between the income and the payout.

In one embodiment, the income of the j-th SP may include an income obtained by the SP from providing services to users. This income may be a basic income of the SP, which may be expressed as:

Iⱼ=pⱼ^{s}bⱼ (4)

where, Iⱼ represents the income of the j-th SP, pⱼ^{s} represents the price of the services provided by the j-th SP (per unit frequency band), and bⱼ represents the spectrum demand amount of the j-th SP.

In one embodiment, the payout of the j-th SP may include a payout indicating that the SP purchases spectrum resources based on the spectrum price. The payout may be a basic payout of the SP, which may be expressed as:

Oⱼ=pᵢ^{o}bⱼ (5)

where, Oⱼ represents the payout of the j-th SP, pᵢ^{o} represents the quotation per unit frequency band of the i-th MNO spectrum, and bⱼ represents the spectrum demand amount of the j-th SP.

Correspondingly, the performance function of the j-th SP may be expressed as:

U_{SP}^{j}=pₛ^{s}bⱼ−pᵢ^{o}bⱼ (6)

In the embodiment described in equation (6), the performance function of the j-th SP is only associated with the SP itself and the MNO, but not with other SPs in the system. When gaming with the MNOs, each SP in the system is considered completely independent, and there is no cooperation mechanism among the SPs.

According to a preferred embodiment, a cooperation mechanism may be introduced among multiple SPs in the wireless communication system, so that more SPs may participate in the process of spectrum transactions. The greater the number of SPs participating in spectrum transactions, the more likely the spectrum resources provided by MNOs will be traded, and the higher the utilization rate of spectrum resources will be. For each piece of spectrum resource provided by the MNOs, there might be a plurality of SPs that participate in the gaming process for the spectrum resource at the same time, but only one SP may finally obtain the spectrum resource. If only the SP that obtains the spectrum resource may earn income, it will not be conducive to facilitating more SPs to participate in the game. To this end, each SP that participates in the gaming process for the specific spectrum resource but does not obtain the specific spectrum resource may be configured to obtain a compensation income from a SP that successfully obtains the specific spectrum resource. The compensation income may be included, as a first compensation income, in the performance function of the SP that has not obtained the spectrum resource.

In this embodiment, the first compensation income obtained by the j-th SP occurs when other SPs except the j-th SP obtain the required spectrum resources. For example, the first compensation income obtained by the j-th SP may be based on the amount of spectrum resources obtained by other SPs (that is, spectrum demand amount by the other SPs). In this case, the income of the j-th SP may be expressed as:

Iⱼ=pⱼ^{s}bⱼ+τⱼ¹Σ^{b}₋ⱼ (7)

where, Iⱼ represents the income of the j-th SP, pⱼ^{s} represents the price of the services provided by the j-th SP (per unit frequency band), bⱼ represents the spectrum demand amount of the j-th SP, and τⱼ¹ represents a first compensation coefficient for the j-th SP (which may be referred to the profit compensation coefficient). In addition, other SPs other than the j-th SP are indicated by −j. Accordingly, b₋ⱼ represents the spectrum demand amounts of other SPs than the j-th SP.

Under this cooperation mechanism, the payout of the j-th SP may include a first compensation payout. The first compensation payout may occur when the j-th SP obtains the required spectrum resource. The first compensation payout may be paid by the j-th SP to other SPs that have not obtained the spectrum resource. For example, the first compensation payout of the j-th SP may be based on the amount of spectrum resources obtained by the SP (that is, spectrum demand amount). In this case, the payout of the j-th SP may be expressed as:

Oⱼ=pᵢ^{o}bⱼ+τ₋ⱼ¹Σbⱼ (8)

where, Oⱼ represents the payout of the j-th SP, pᵢ^{o} represents the quotation per unit frequency band of the spectrum of the i-th MNO, bⱼ represents the spectrum demand amount of the j-th SP, −j represents other SPs than the j-th SP, and τ¹₋ⱼ represents a compensation coefficient for the other SPs than the j-th SP.

Based on equations (7) and (8), the performance function of the j-th SP under the cooperation mechanism may be obtained:

U_{SP}^{j}=(pⱼ^{s}bⱼ+τⱼ¹Σ^{b}₋ⱼ)−(pⱼ^{o}bⱼ+τ₋ⱼ¹Σb₋ⱼ) (9)

In above preferred embodiment, the performance function of each SP is not only associated with the SP and the corresponding MNOs, but also associated with other SPs participating in the gaming process. For each SP, even if the SP does not obtain a spectrum resource from its participated gaming processes (and therefore cannot obtain service income based on the spectrum resource), the SP may still obtain a first compensation income from another SP that obtains the spectrum resource. This forms a virtual cooperation mechanism among multiple SPs. This virtual cooperation mechanism may facilitate SPs to participate in the gaming process. When more SPs participate in the gaming process, the tradable idle spectrum resources provided by MNOs may be more fully utilized, thereby improving the spectrum utilization efficiency of the wireless communication system.

According to a further preferred embodiment, in order to ensure the implementation of the above cooperation mechanism, dishonest SPs in the system may be punished. For example, when it is detected that a specific SP that obtained the spectrum resource refuses to pay other SPs the first compensation income, the specific SP may be regarded as a dishonest SP. A blockchain node may detect the dishonest SP, and execute penalty for the dishonest SP. The penalty may be implemented as a second compensation payout of the dishonest SP. Accordingly, the second compensation payout may be paid by the dishonest SP to other SPs as a second compensation income of the other SPs.

In this embodiment, spectrum vouchers may be used as a tool for transferring the second compensation income and the second compensation payout among various SPs. Spectrum vouchers may be virtual digital currencies that may be used for spectrum transactions. When the j-th SP acts as a dishonest SP, the second compensation payout paid from it to other SPs in the system may be calculated as τⱼ²sⱼ^{c}, where τⱼ² represents a second compensation coefficient (punishment compensation coefficient) of the j-th SP, while sⱼ^{c} represents the spectrum voucher held by the j-th SP. When other SPs are a dishonest SP, the second compensation income obtained by the j-th SP from the other dishonest SPs may be expressed as τⱼ²s₋ⱼ^{c}, where τⱼ² represents the second compensation coefficient (punishment compensation coefficient) of the j-th SP, while s₋ⱼ^{c} represents spectrum vouchers held by the other SPs than the j-th SP in the system.

Accordingly, the income and payout of the j-th SP may be expressed as:

Iⱼ=pⱼ^{s}bⱼ+τⱼ¹Σb₋ⱼ+τⱼ²s₋₁^{c} (10)

Oⱼ=pᵢ^{o}bⱼ+τ₋ⱼ¹Σbⱼ+τⱼ²sⱼ^{c} (11)

Equation (10) shows that the income of each SP may include the basic income of the SP for providing services (i.e., the first item), the first compensation income (i.e., the second item) obtained from other SPs which obtain spectrum resources, and the second compensation income (i.e., the third item) obtained from dishonest SPs.

Equation (11) shows that the payout of each SP may include the basic payout for the SP to purchase spectrum resources (i.e., the first item), the first compensation payout (i.e., the second item) provided to other SPs which do not obtain spectrum resources, and the second compensation payout (i.e., the third item) paid by the SP.

Accordingly, the performance function of the j-th SP may be expressed as:

U_{SP}^{j}=(pⱼ^{s}bⱼ+τⱼ¹Σb₋ⱼ+τⱼ²s₋ⱼ^{c})−(pᵢ^{o}bⱼ+τ₋ⱼ¹Σbⱼ+τⱼ²s₋ⱼ^{c}) (10)

Maximizing the benefit of the SP may be expressed as the following optimization problem:

$${max}_{{τ}^{1} > 0 , {τ}^{2} > 0} {U}_{SP}^{j} , s . t . {\sum }_{{j = 1}^{}}^{k} {b}_{j} \leq B \qquad ( 13 )$$

According to an embodiment, in the blockchain system, a specific virtual digital currency may be used to measure the income of the SP. Therefore, the income of the above j-th SP may be converted into the amount of virtual digital currency based on a predetermined conversion coefficient. Accordingly, the performance function of the j-th SP may be expressed as:

U_{SP}^{h}=ηⱼ(pⱼ^{s}bⱼ+τⱼ¹Σb₋ⱼ)+τⱼ²s₋ⱼ^{c}−(pⱼ^{o}bⱼ+τ₋ⱼ¹Σb₋ⱼ+τⱼ²sⱼ^{c}) (14)

where ηⱼ represents the conversion coefficient for the virtual digital currency of the j-th SP.

In the above further preferred embodiment, the performance function of each SP is not only associated with the SP itself and the corresponding MNOs, but also associated with behaviors of other SPs participating in the gaming process, which not only involves behaviors of other MNOs in obtaining spectrum resources, but also involve whether other SPs have honestly fulfilled the cooperation mechanism.

According to an embodiment, this virtual cooperation mechanism may be executed by the blockchain trading platform described herein. For example, each SP may send its associated compensation coefficients (e.g., the first compensation coefficient and/or the second compensation coefficient) to a blockchain node (e.g., 1410). These compensation coefficients may be sent separately, for example, or may be included in the demand information of the SP. Blockchain nodes may use these compensation coefficients to calculate the performance function of the SP.

In one embodiment, multiple SPs in the wireless communication system may agree on common compensation coefficients with each other. For example, before participating in a gaming process, the multiple SPs may negotiate in advance to determine one or more consistent compensation coefficients, and send the determined one or more compensation coefficients to blockchain nodes. These compensation coefficients may be used in the performance function of each of the multiple SPs.

In another embodiment, the compensation coefficients applicable to each of multiple SPs may be determined by blockchain nodes. For example, each SP may send its own range of compensation coefficients to blockchain nodes. The blockchain nodes may group a plurality of SPs that have matching (e.g., overlapping) compensation coefficient ranges into one group, and determine a consistent compensation coefficient within the overlapping compensation coefficient range for each SP in the group. Multiple SPs in the same group have a consistent compensation coefficient and may be allowed to participate in a gaming process for the same spectrum resource. Accordingly, SPs with mismatched compensation coefficient ranges may be assigned to different groups, and may participate in gaming processes for different spectrum resources.

According to an embodiment, the phase of determining common/matching compensation coefficients may be referred to as a virtual cooperation phase. The virtual cooperation phase may be performed before SPs determines demand information. For example, the virtual cooperation phase may be performed prior to step 6010 in FIG. 6.

According to an embodiment, after the virtual cooperation phase, multiple SPs may enter a selfish competition phase. In the selfish competition phase, each SP may upload its own spectrum demand amount to blockchain nodes, and independently select and purchase spectrum resources. Blockchain nodes perform integration and matching according to the information uploaded by the MNOs and the SPs, enabling spectrum prices to be determined to achieve spectrum transactions. The selfish competition phase may include, for example, steps 6010 to 6100 in FIG. 6.

According to an embodiment, after a spectrum transaction is determined, it may optionally enter a fair compensation phase. In the fair compensation phase, it may be detected whether a specific SP that finally obtains a spectrum resource refuses to pay compensation to other SPs. If it is detected that the specific SP refuses to pay the sufficient compensation payout to the other SPs, the specific SP may be penalized and enforced to pay a second compensation payout (i.e., a punitive payout). The fair compensation phase may be performed, for example, after step 6100 in FIG. 6.

This disclosure realizes a cooperation mechanism for spectrum transactions through blockchain nodes, which appears as a compensation-punishment-incentive mechanism. This cooperation mechanism may maximize the benefits of SPs while ensuring the fairness of competition among the SPs.

### 5-3-3. Performance Function of Users

According to an embodiment, the performance function of a user may be expressed as a difference between the user's benefit from the purchased corresponding service and the user's payout for purchasing the service. The user's benefit may be represented by, for example, QoS (Quality of Service). Accordingly, the performance function of the user may be expressed as:

$${U}_{u}^{j} = δ {Q}_{o s} ( {r}_{{s}_{j}} ) - {p}_{j}^{s} {\sum }_{j = 1}^{K} {b}_{j} \qquad ( 15 )$$

Maximizing the benefit of the user may be expressed as an optimization problem:

$${max}_{δ > 0} {U}_{u}^{j} ( {p}_{j}^{s} ) , \qquad ( 16 )$$

$$s . t . {S}_{j} ∈ S$$

where, Uᵤ^{j} may represent the user's performance. Due to the large number of users, it is not practical to model the behavior of a single user, so here is the description of the performance of users who choose the same type of service. δ represents a parameter that converts user satisfaction with QoS into performance. Qₒₛ(rₛ_{ⱼ}) represents the performance when a certain proportion of users select the j-th SP service. Generally, Qₒₛ(rₛ_{ⱼ}) is set as a continuous and monotonous non-negative function, and bⱼ represents the spectrum demand amount of the j-th SP, and pⱼ^{s} represents the service price provided by the j-th SP.

For the sake of clarity, Table 1 below lists the meanings of above parameters symbols:

TABLE 1

| Symbol | Description |
|---|---|
| N | Number of MNOs |
| K | Number of SPs |
| B | Total amount of available spectrum |
| pₜ^{o} | Quotation per unit frequency band of the i-th MNO |
| pⱼ^{s} | Price of the service provided by the j-th SP |
| bⱼ | Spectrum demand amount of the j-th SP |
| q | Frequency band that may be purchased per unit price |
| wⱼ | Bidding strategy of the j-th SP |
| m [symbol] | Construction cost coefficient of the i-th MNO |
| ηⱼ | Coefficient of converting the income of the j-th SP into |
| | spectrum coin |
| sⱼ^{c} | Spectrum vouchers held by the j-th SP |
| δ | Parameter that converts user satisfaction with QoS into |
| | performance |
| τⱼ¹ | A first compensation coefficient of the j-th SP |
| | (profit compensation coefficient) |
| τⱼ² | A second compensation coefficient of the j-th SP |
| | (penalty compensation coefficient) |

[symbol]

indicates data missing or illegible when filed

### 5-4. Static Game and Dynamic Game

As described above, spectrum prices for spectrum transactions between MNOs and SPs may be determined through gaming processes. The gaming processes may adopt a static game method or a dynamic game method. Table 2 gives the essential elements of a game model of the game methods.

TABLE 2

| Essential Elements | Specific Description |
|---|---|
| Research object | Spectrum price |
| Main participants | MNOs, SPs and users |
| Behaviors | Select spectrum prices, spectrum demand |
| | amounts, service types |
| Benefits | Performances of MNOs, SPs and users |
| Nash equilibrium | Spectrum price when benefit is the |
| | maximized |

Embodiments of a static game and embodiments of a dynamic game will be described respectively below.

### 5-4-1. Static Game

In a static game, participants participating in the game choose their strategies simultaneously, and every time each participant chooses its own strategy, other participants may know the strategy selected by that participant.

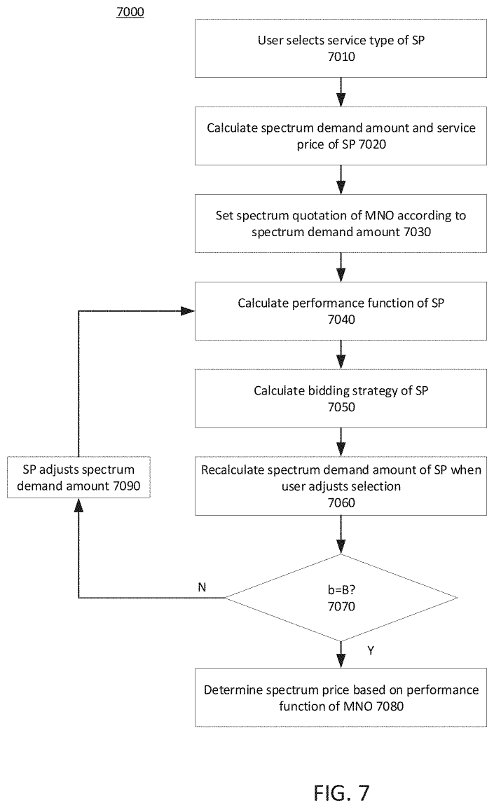

FIG. 7 illustrates a flowchart of a static game 7000 according to an embodiment of the disclosure. In the game between a SP and a user, the SP, as a leader, is able to predict the reaction of the user as a follower to a strategy given by the SP, so the SP may preliminarily announce to the user service types and service prices that the SP may provide. In step 7010, the user may select a service type of the SP. Specifically, the user may select a respective service type corresponding to the SP according to the service price and his own communication needs. In step 7020, the spectrum demand amount and service price of the SP may be calculated. Specifically, for each SP, the spectrum demand amount of users who choose the service of the SP may be calculated, and the initial service price may be determined. The determined spectrum demand amount may be sent (e.g. via a blockchain node) to a MNO. In step 7030, the MNO may set an initial spectrum quotation (quotation per unit frequency band), which may be sent to the SP (e.g., via the blockchain node). Then in step 7040, the performance function of the SP may be calculated. In step 7050, a bidding strategy for the SP may be calculated. Specifically, for the j-th SP, the derivative of the performance function U_{SP}^{j} of the SP to the bidding strategy Wⱼ of the SP may be calculated, and a bidding strategy that makes the derivative 0

$$( i . e . , \frac{\partial {U}_{SP}^{j}}{\partial {w}_{j}} = 0 )$$

is used as the bidding strategy of the SP. Since the static game method is adopted, the j-th SP may regard bidding strategies of other SPs and spectrum quotations of MNOs as given values. In step 7060, when the user adjusts its own service selection, the spectrum demand amount of the SP may be calculated again. In step 7070, it may be determined whether the spectrum demand amount b of all SPs is equal to the total available spectrum B that is available for spectrum transactions. In response to determining b=B, the process may proceed to step 7080. In the step 7080, a spectrum price may be determined based on the performance function of the MNO. For example, for the i-th MNO, the derivative of the performance function U_{MNO}ⁱ of the MNO to the unit spectrum quotation pᵢ^{o} of the MNO may be calculated, and a unit spectrum quotation that makes the derivative 0

$$( i . e . , \frac{\partial {U}_{MNO}^{i}}{\partial {p}_{i}^{o}} = 0 )$$

is used as the final spectrum price. In response to determining that b≠B, the process may proceed to step 7090. In the step 7090, the SP may adjust the spectrum demand amount. For example, the j-th SP may increase the spectrum demand amount of the SP by a certain amount Δ, that is, bⱼ=bⱼ+Δ. The static game 7000 may then proceed to step 7040 to perform steps 7040 to 7070 repeatedly. In a case that b=B cannot be satisfied, the static game 7000 may iterate until a termination condition is reached. The termination condition is, for example, that the times of repeatedly performing steps 7040 to 7070 has reached a specified threshold.

### 5-4-2. Dynamic Game

In some spectrum transactions, due to the competitive relationship between various SPs and the selfishness of each SP to maximize its own benefit, a SP cannot know decisions and benefits of other SPs, and may only obtain spectrum quotation information from MNOs. In this case, a dynamic game method is usually adopted. One example of the dynamic game is a Stackelberg game. In the Stackelberg gaming process, SPs may obtain the Nash equilibrium solution by relying on interactions with MNOs.

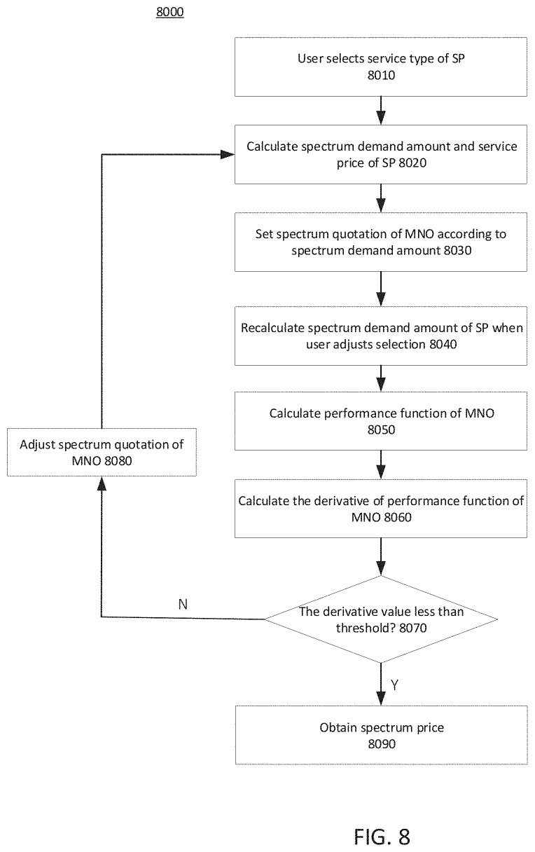

FIG. 8 illustrates a flowchart of a dynamic game 8000 according to an embodiment of the disclosure. As described above, in the game between a SP and users, the SP (as a leader) may predict the reaction of the users (as followers) to a strategy that is given by the SP, so the SP may preliminarily announce to the users service types and services prices that the SP may provide. In step 8010, each user may select a service type of the SP. Specifically, the user may select a respective service type corresponding to the SP according to the service price and his own communication needs. In step 8020, the spectrum demand amount and service price of the SP may be calculated. Specifically, for each SP, the spectrum demand amount of users who choose the service of that SP may be calculated, and the initial service price may be determined. The determined spectrum demand may be sent (e.g. via a blockchain node) to MNOs. In step 8030, the MNOs may set an initial spectrum quotation (quotation unit frequency band), which may be sent to the SP (e.g., via the blockchain node). In step 8040, when the user adjusts his own service selection, the spectrum demand amount of the SP may be calculated again. In step 8050, the performance function U_{MNOi} of the MNO may be calculated. In step 8060, the derivative

$$\frac{\partial {U}_{{MNO}_{i}}}{\partial {p}_{i}^{o}}$$

of the performance function of the MNO to the unit spectrum price pᵢ^{o} of the MNO may be calculated. In step 8070, it may be determined whether the value of the derivative is smaller than a preset stability threshold ϑ, that is, it is determined whether

$$\frac{\partial {U}_{{MNO}_{i}}}{\partial {p}_{i}^{o}} < ϑ$$

is established. In response to determining in step 8070 that the value of the derivative is not less than the stability threshold, dynamic game 8000 may proceed to step 8080. In step 8080, the MNO may adjust the spectrum quotation in a direction of increasing its own benefit. For example, it may let

$${p}_{i}^{o} = {p}_{i}^{o} + α \cdot \frac{\partial {U}_{{MNO}_{i}}}{\partial {p}_{i}^{o}} ,$$

where α is an adjustment coefficient. Then, steps 8020 to 8070 may be repeated. In response to determining in step 8070 that the value of the derivative is less than the stability threshold, it may be considered that a Nash equilibrium condition has been reached, and dynamic game 8000 may proceed to step 8090. In step 8090, the current spectrum quotation of the MNO may be applied to the spectrum transaction as the final spectrum price, and dynamic game 8000 may end. If the Nash equilibrium condition cannot be reached all the time, dynamic game 8000 may iterate until a termination condition is reached. The termination condition is, for example, that the times of repeatedly performing steps 8020 to 8070 reach a specified threshold.

The dynamic game in FIG. 8 is a Stackelberg game, and the gaming process is performed in an iterative manner. As the number of iterations increases, the game result tends to be stable, and finally reaches the Nash equilibrium condition. The Nash equilibrium condition mentioned here may be defined as U_{MNO}ⁱ(pᵢ^{o}^{^{*}}, p₋ᵢ^{o})≥U_{MNO}ⁱ(pᵢ^{o}, p₋ᵢ^{o}). According to an embodiment, the Nash equilibrium condition may be transformed into determining whether

$$\frac{\partial {U}_{{MNO}_{i}}}{\partial {p}_{i}^{o}} < ϑ$$

is established. That is to say, if the derivative

$$\frac{\partial {U}_{{MNO}_{i}}}{\partial {p}_{i}^{o}}$$

of the performance function of the MNO to the unit spectrum quotation pᵢ^{o} of the MNO is within the appropriate stability threshold ϑ, the gaming process may be considered to have satisfied the Nash equilibrium condition, namely, reached an equilibrium state.

By adopting a non-cooperative Stackelberg gaming process with a layered structure to determine the spectrum price, modeling through layering game on spectrum transactions processes is realized. The optimal spectrum sharing and pricing strategy may be obtained by using this model, so as to maximize the overall benefits of the participants in spectrum transactions. In addition, through the virtual cooperation phase, selfish competition phase and fair compensation phase, the cooperation mechanism in the process of spectrum transactions is realized. When multiple SPs participate in a game under the cooperation mechanism, the benefits of the SPs may be maximized. The above gaming process and the cooperation mechanism used therein may be mainly executed by each blockchain node of the blockchain trading platform. For example, they may be implemented as smart contracts executed on these blockchain nodes. A smart contract is a contract clause jointly formulated by users of the blockchain trading platform. Spectrum sharing and leasing strategies are encoded as agreements executed in digital form. The agreements define rights and obligations of both parties. After a spectrum transaction is reached, the smart contract will transfer the spectrum usage right among participants in the spectrum transaction within a certain period of time, and use virtual digital currency to pay various fees.

### 6. BLOCK GENERATION AND VERIFICATION

According to an embodiment, a spectrum transaction may be performed after a spectrum price for the spectrum transaction is determined. Blockchain nodes in a blockchain trading platform described herein may record information of spectrum transactions between SPs and MNOs in a blockchain in the form of blocks.

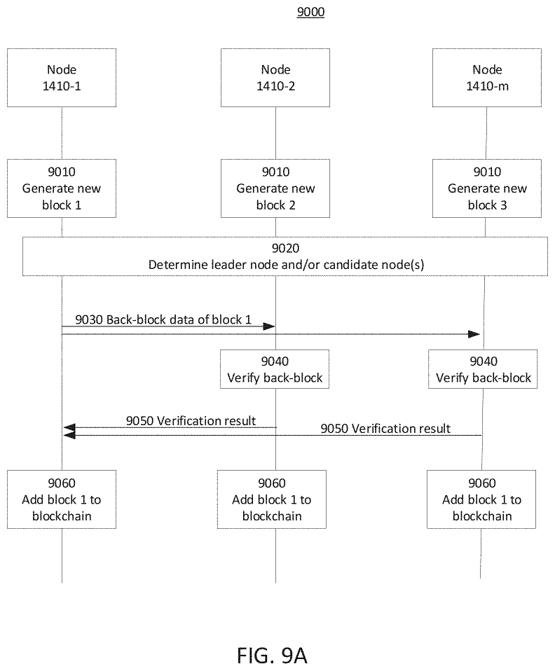

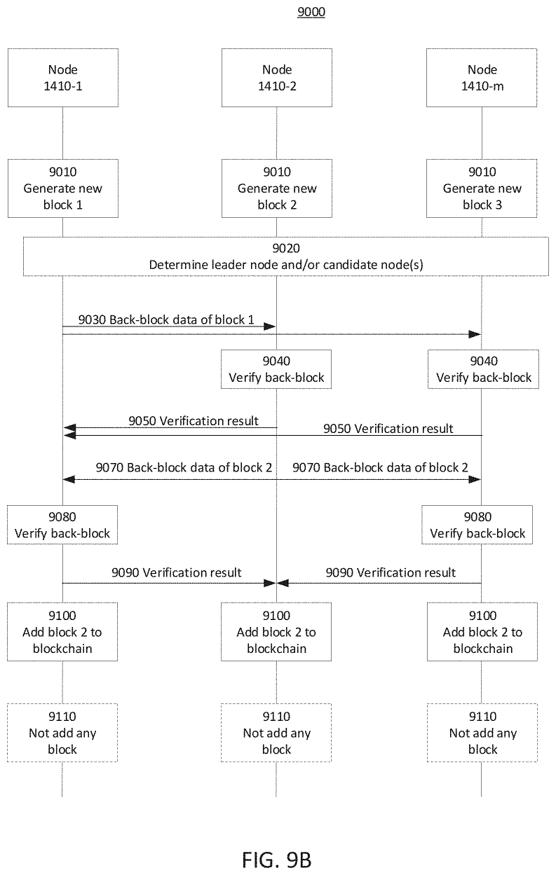

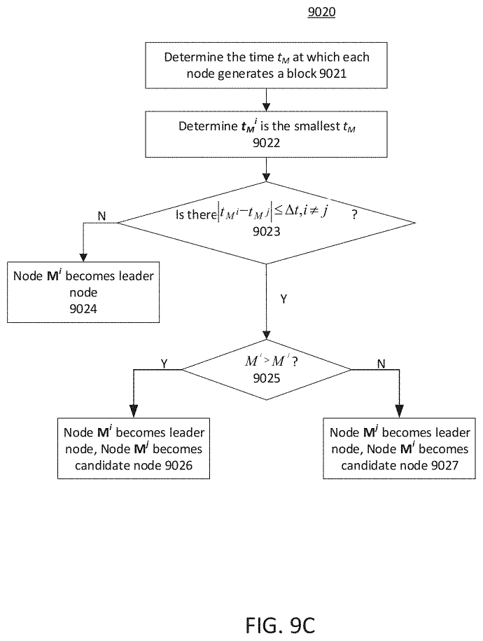

FIGS. 9A-9B illustrate a signaling flow diagram of a process 9000 of recording information of a spectrum transaction in a blockchain in the form of blocks according to an embodiment. The process 9000 specifically describes a consensus verification process of a blockchain trading platform. One or more blockchain nodes 1410-1, 1410-2, . . . , 1410-m in FIGS. 9A-9B may correspond to the blockchain nodes 1410-1, 1410-2, . . . , 1410-m described in FIG. 6.

In step 9010, all blockchain nodes (for example, blockchain nodes 1410-1, 1410-2, . . . , 1410-m described in FIG. 6) participating in the spectrum transaction may generate new blocks that will potentially be added to the blockchain nodes. In FIG. 9A, new blocks generated by blockchain nodes 1410-1, 1410-2, and 1410-m are denoted as new block 1, new block 2, and new block 3, respectively. Specifically, each of these blockchain nodes may query transaction items in the blockchain to collect unverified transactions (transactions that have been verified will be recorded in a distributed blockchain ledger of various blockchain nodes). Each blockchain node may look for a random number conforming to an operation threshold condition based on a hash operation. Once the random number is found, each blockchain node may generate a new block for that blockchain node based on the collected unverified transactions.

In step 9020, a leader node may be determined from all blockchain nodes that have generated a new block. The leader node may be selected as a blockchain node to generate a earliest new block among all the blockchain nodes of the blockchain network.

According to an embodiment, in order to avoid a “pre-fork” of the blockchain caused by multiple blockchain nodes generating new blocks at the same time, different calculation threshold conditions for hash operations may be set for different blockchain nodes. For example, the operation threshold condition for each blockchain node may be associated with a coin age of that blockchain node. The coin age may be defined as the amount of virtual currency held by the blockchain node multiplied by the time the blockchain node has held the virtual currency. An operational threshold condition may be characterized as being less than some specified threshold. In order to generate a new block, a blockchain node need to solve a hash-based mathematical problem to find a random number smaller than this specified threshold. Accordingly, a blockchain node with a larger coin age may have a larger operation threshold condition, so the blockchain node may find a random number conforming to the operation threshold condition faster, thereby generating a new block faster than other blockchain nodes with smaller coin ages.

According to an embodiment, in step 9020, candidate nodes may also be determined. A candidate node may be a blockchain node in the blockchain network that meets following conditions: a difference between the time when the candidate node generates a new block and the time when the leader node generates a new block does not exceed a predetermined time threshold, and the coin age of the candidate node is less than the coin age of the leader node. Candidate nodes may provide additional verification as described further below.

FIG. 9C illustrates a flowchart of a process for determining a leader node and/or a candidate node in step 9020 according to an embodiment. Step 9020 may include sub-step 9021 to sub-step 9027.

In sub-step 9021, the time t_{M} at which each blockchain node in a blockchain trading platform generates a new block may be determined. For example, each blockchain node may maintain a timer to record a time value at which it has generated a new block.

Subsequently, the process may proceed to sub-step 9022. In this sub-step, the smallest t_{M} may be determined. For example, each blockchain node may send its own time value for generating the new block to other blockchain nodes. Blockchain nodes that receive this time may sort the time values to determine the smallest t_{M}. As an example, we assume that the time value t_{M}ⁱ at which the i-th blockchain node Mⁱ generates the new block is determined to be the smallest value of t_{M}.

Subsequently, the process may proceed to sub-step 9023. In this sub-step, it may be determined whether there are one or more blockchain nodes M^{j} different from the blockchain node Mⁱ, so that a difference between the time value t_{M}^{j} (when the blockchain node M^{j} generates a new block) and the time value t_{M}ⁱ (when the blockchain node Mⁱ generates a new block) is less than a predetermined time threshold Δt, that is, it is determined whether there is a blockchain node M^{j} conforming to the condition

$$\vert {t}_{{M}^{i}} - {t}_{{M}^{j}} \vert \leq Δ t , i \neq j .$$

If there is no blockchain node M^{j} conforming to this condition, then the process proceeds to sub-step 9024. In this sub-step, the blockchain node Mⁱ may be determined as the leader node. Also, it may be determined that there is no candidate node.

If there is one or more blockchain nodes M^{j} conforming to the condition, then it may be determined that there are candidate node(s). In this case, the leader and candidate node may be determined based on the coin ages of the blockchain nodes Mⁱ and M^{j}. The process may proceed to sub-step 9025. In this sub-step, the coin ages of Mⁱ and M^{j} may be compared. A coin age may be defined as the amount of virtual currency held by a blockchain node multiplied by the time the blockchain node has held the virtual currency. A blockchain node with a greater coin age may be determined as a leader node, and a blockchain node with a smaller coin age may be determined as a candidate node.

If it is determined in sub-step 9025 that the coin age of the blockchain node Mⁱ is greater than the coin age of the blockchain node M^{j}, the process may proceed to sub-step 9026, in which the blockchain node Mⁱ is determined as the leader node, and the node M^{j} is determined as the candidate node. Otherwise, the process may proceed to sub-step 9027, wherein the blockchain node M^{j} is determined as the leader node, and the blockchain node Mⁱ is determined as the candidate node. Each blockchain node may also maintain a counter. The blockchain node that is determined to be the leader node or the candidate node may add 1 to the value of its own counter to mark its current role as a leader node or a candidate node. In addition, the blockchain node that is determined to be the leader node may set its coin age to zero.

It should be noted that although FIG. 9C discusses one leader node and one candidate node, in other embodiments, there may be multiple candidate nodes at the same time. The number of possible candidate nodes may be reduced by appropriately setting the predetermined time threshold Δt. And, as mentioned above, different computing threshold conditions based on coin ages may be used for different blockchain nodes, which may decentralize time values for each blockchain node to generate a new block, thereby avoiding multiple blockchain nodes to generate new blocks within a close time.

Returning now to FIGS. 9A-9B. In the embodiments shown in FIGS. 9A-9B, it is assumed that blockchain node 1410-1 is determined as the leader node in step 9020. Blockchain node 1410-1, as the leading node, may send in step 9030 the generated new block (for example, block 1) to other blockchain nodes 1410-2 to 1410-m for verification. Preferably, blockchain node 1410-1 may not send the entire new block, but only a part of the block. The part sent may be referred to as back-block data. Other data of the block may be referred to as front-block data. The back-block data may only contain some key items of the spectrum transaction (for example, spectrum price), but not the identity information of transaction participants, for example. This may reduce the time for verification, thereby speeding up the completion of the spectrum transaction. Additionally, the back-block data may also include a random number found by the leader node through hash operations (that is, a random number that the leader node finds to meet the operation threshold condition in order to generate a new block). It is very difficult for other blockchain nodes performing verification to find the random number by doing hash operations, which usually takes a long time. If the leader node has generated a new block (that is, has found a suitable random number) and includes the random number in the back-block data to send to other blockchain nodes, other blockchain nodes only need to perform operational verification. Through this verification manner, the time for verification may be significantly saved, thereby further speeding up the verification.

In step 9040, the blockchain nodes 1410-2 to 1410-m performing verification may verify the back-block data received from the leader node. For example, if the blockchain node performing the verification has obtained the result of its own hash operations, the blockchain node may determine whether its own hash operation result is consistent with the hash operation result from the leader node, so as to compare its own data with the received back-block data. Additionally or alternatively, the blockchain node performing the verification may verify whether the random number contained in the received back-block data satisfies the operation threshold condition. Additionally, since the blockchain system networking mode is encapsulated in the network layer of the blockchain architecture, the blockchain node may also verify the validity of the transaction data in the back-block data from the aspects of data structure and syntax standardization against a predefined standard list. In addition, for each blockchain node participating in the gaming process for the spectrum price, it may also verify whether the spectrum price in the back-block data is the final spectrum price determined by the gaming process.

In step 9050, each blockchain node performing the verification may send a verification result to the leader node 1410-1. The verification result of each blockchain node performing the verification may indicate whether the new block (for example, back-block data) generated by the leader node 1410-1 is successfully verified by the blockchain node. The leader node 1410-1 may count a ratio of the number of obtained verified results with respective to the total number of all blockchain nodes in the blockchain trading platform. If the ratio exceeds a predetermined threshold (for example, 50%), it may be considered that the new block generated by the leader node 1410-1 has passed the verification, or in other words, various blockchain nodes in the blockchain trading platform have reached a consensus on the block. Otherwise, it may be considered that the new block generated by the leader node 1410-1 has failed to pass the verification.

FIG. 9A illustrates an example embodiment in which a new block generated by the leader node 1410-1 has passed the verification. Accordingly, after step 9050, the new block generated by the leader node 1410-1 may be added to the blockchain in step 9060. Subsequently, all blockchain nodes may update their local blockchain ledgers. The process 9000 may end.

FIG. 9B illustrates an example embodiment in which a new block generated by the leader node 1410-1 failed to pass the verification. In this case, the new block (e.g., block 1) generated by the leader node will be discarded. After step 9050, an additional verification may be performed on a new block (e.g., block 2) generated by candidate node 1410-2. The additional verification may be done, for example, only for back-block data of the new block generated by the candidate node 1410-2. Specifically, the candidate node 1410-2 may send its back-block data to other blockchain nodes in the blockchain trading platform in step 9070. Each blockchain node performing verification may verify the back-block data in step 9080, and send a verification result to the candidate node 1410-2 in step 9090. The verification here may be similar to the verification in step 9040. If the back-block data generated by the candidate node 1410-2 passes the verification, then in step 9100, the new block generated by the candidate node 1410-2 may be added into the blockchain. Accordingly, the process 9000 may end.

If the back-block data generated by the candidate node 1410-2 also failed to pass the verification, then in step 9110, the new block generated by the candidate node 1410-2 may be discarded. If there are one or more other candidate nodes, similar verifications may be performed on each of these candidate nodes until the back-block data of one candidate node passes the verification. If the back-block data of all candidate nodes fail to pass the verification, the process 9000 may also end. At this point, new block generated by each blockchain node may be discarded.

In the above consensus verification process, not all new blocks generated by each blockchain node in the blockchain trading platform are verified, but only new blocks generated by the leader node and candidate nodes are verified. The maximum number of verification rounds of the blockchain trading platform is equal to the number of leader nodes and candidate nodes. This avoids repeated verifications, thereby speeding up spectrum transactions.

According to a preferred embodiment, only two rounds of verification may be performed. In this embodiment, only the new blocks generated by one leader node and one candidate node may be verified. This further limits the number of rounds of verification and ensures the efficiency of verification.

It may be seen that the present disclosure also provides a new consensus verification method. The concept of back-block is proposed in the transaction verification phase. The consensus verification process may only verify back-block data containing key information, which may improve the efficiency of verification. Moreover, in this consensus verification method, when the block verification of the leader node does not reach consensus (does not pass), the candidate node may replace the leader node to re-initiate the block verification request. By limiting the number of block verifications, repeated verifications may be avoided, thereby further improving the efficiency of verification. This may reduce the delay caused by the blockchain trading platform and help to increase the speed of spectrum transactions based on blockchain technology, thereby protecting the benefits of MNOs and SPs. The blockchain technology adopted in this disclosure is not only applicable to consortium chain systems, but also applicable to other types of blockchain systems, and has wide applicability.

### 7. SPECIFIC EXAMPLES

### 7-1. Applicable Examples of Electronic Device for MNOs

### First Applicable Example

It should be understood that the term base station in this disclosure has its full breadth of ordinary meaning and includes at least a wireless communication station used as part of a wireless communication system or radio system to facilitate communication. Examples of base stations may be, for example, but not limited to, the following: a base station may be one or both of a base transceiver station (BTS) and a base station controller (BSC) in a GSM system, may be one or both of a radio network controller (RNC) and NodeB in a WCDMA system, may be an eNB in a LTE and LTE-Advanced system, or may be a corresponding network node in a future communication system (for example, a gNB that may appear in a 5G communication system, etc.). In D2D, M2M, and V2V communication scenarios, a logical entity having control functionality on communications may also be referred to as a base station. In a cognitive radio communication scenario, a logical entity that plays a role in spectrum coordination may also be referred to as a base station.

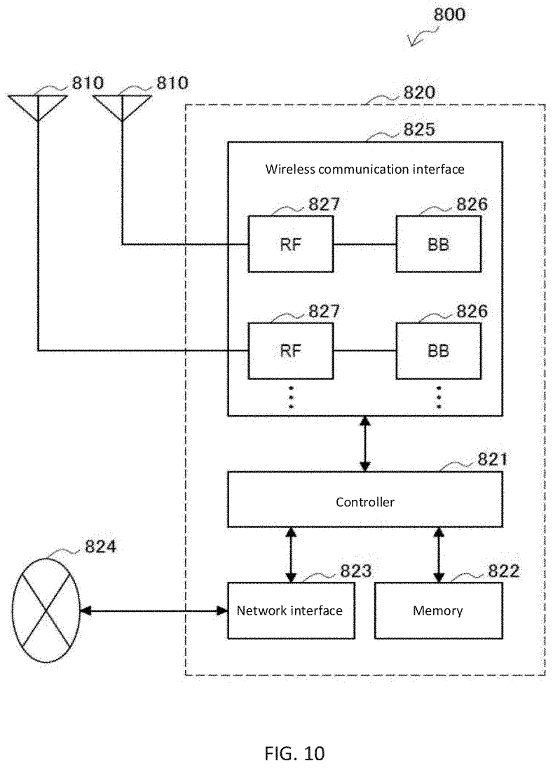

FIG. 10 is a block diagram illustrating a first example of a schematic configuration of an MNO device to which the technology of the present disclosure may be applied. The MNO device may be an electronic device for performing operations of MNO 1100 according to an embodiment of the present disclosure. The electronic device for MNO 1100 is shown as gNB 800. Wherein, gNB 800 includes multiple antennas 810 and base station device 820. The base station device 820 and each antenna 810 may be connected to each other via an RF cable.

Each of the antennas 810 includes multiple antenna elements (such as multiple antenna elements included in a Multiple-Input-Multiple-Output (MIMO) antenna), and is used by the base station device 820 to transmit and receive wireless signals. As shown in FIG. 10, the gNB 800 may include multiple antennas 810. For example, the multiple antennas 810 may be compatible with multiple frequency bands used by the gNB 800. FIG. 10 illustrates an example in which the gNB 800 includes multiple antennas 810 that may be used to implement a multi-carrier system of an embodiment of the present disclosure.

The base station device 820 includes a controller 821, a memory 822, a network interface 823 and a wireless communication interface 825.

The controller 821 may be, for example, a CPU or a DSP, and operates various functions of higher layers of the base station device 820. For example, the controller 821 may include the above processing circuit 523 or 1223. For example, the controller 821 generates data packets from data in signals processed by the wireless communication interface 825 and transfers the generated packets via the network interface 823. The controller 821 may bundle data from a plurality of baseband processors to generate a bundled packet, and transfer the generated bundled packet. The controller 821 may have logical functions to perform controls such as radio resource control, radio bearer control, mobility management, admission control and scheduling. The controls may be performed in conjunction with nearby gNBs or core network nodes. The memory 822 includes RAM and ROM, and stores programs executed by the controller 821 and various types of control data (such as a terminal list, transmission power data, and scheduling data).

The network interface 823 is a communication interface for connecting the base station device 820 to the core network 824. The controller 821 may communicate with a core network node or another gNB via the network interface 823. In this case, the gNB 800 and the core network nodes or other gNBs may be connected to each other through a logical interface (such as an S1 interface and an X2 interface). The network interface 823 may also be a wired communication interface or a wireless communication interface for radio backhaul. If the network interface 823 is a wireless communication interface, the network interface 823 may use a higher frequency band for wireless communication than the frequency band used by the wireless communication interface 825.

The wireless communication interface 825 supports any cellular communication scheme (such as Long Term Evolution (LTE) and LTE-Advanced), and provides wireless connection to a terminal located in a cell of the gNB 800 via the antenna 810. The wireless communication interface 825 may generally include, for example, a baseband (BB) processor 826 and an RF circuit 827. The BB processor 826 may perform, for example, encoding/decoding, modulation/demodulation, and multiplexing/demultiplexing, and performs various types of signal processing of layers (for example, L1, Medium Access Control (MAC), Radio Link Control (RLC), and Packet Data Convergence Protocol (PDCP)). Instead of the controller 821, the BB processor 826 may have a part or all of above logical functions. The BB processor 826 may be a memory storing a communication control program, or a module including a processor and related circuit configured to execute the program. Updating the program may change functions of the BB processor 826. The module may be a card or a blade inserted into a slot of the base station device 820. Alternatively, the module may also be a chip mounted on a card or blade. Meanwhile, the RF circuit 827 may include, for example, a mixer, a filter, and an amplifier, and transmit and receive wireless signals via the antenna 810.

As shown in FIG. 10, the wireless communication interface 825 may include multiple BB processors 826. For example, the multiple BB processors 826 may be compatible with multiple frequency bands used by the gNB 800. As shown in FIG. 10, the wireless communication interface 825 may include multiple RF circuits 827. For example, the multiple RF circuits 827 may be compatible with multiple antenna elements. Although FIG. 10 illustrates an example in which the wireless communication interface 825 includes multiple BB processors 826 and multiple RF circuits 827, the wireless communication interface 825 may also include a single BB processor 826 or a single RF circuit 827.

In the gNB 800 shown in FIG. 10, one or more components for performing the functions of the MNO described in this disclosure may be implemented in the wireless communication interface 825. Alternatively, at least a part of these components may be implemented in the controller 821. For example, the gNB 800 contains a portion (for example, the BB processor 826) or the whole of the wireless communication interface 825, and/or a module including controller 821, and one or more components may be implemented in the module. In this case, the module may store a program for allowing the processor to function as one or more components (in other words, a program for allowing the processor to perform operations of the one or more components), and may execute the program. As another example, a program for allowing a processor to function as one or more components may be installed in the gNB 800, and the wireless communication interface 825 (for example, the BB processor 826) and/or the controller 821 may execute the program. As above, as an apparatus including one or more components, a gNB 800, a base station device 820 or a module may be provided, and a program for allowing the processor to function as one or more components may be provided. In addition, a readable medium in which the program is recorded may be provided.

In addition, in the gNB 800 shown in FIG. 10, the communication unit for the electronic device of the MNO may be implemented in the wireless communication interface 825 (for example, the RF circuit 827). In addition, the communication unit may also be implemented in the controller 821 and/or the network interface 823.

### Second Applicable Example

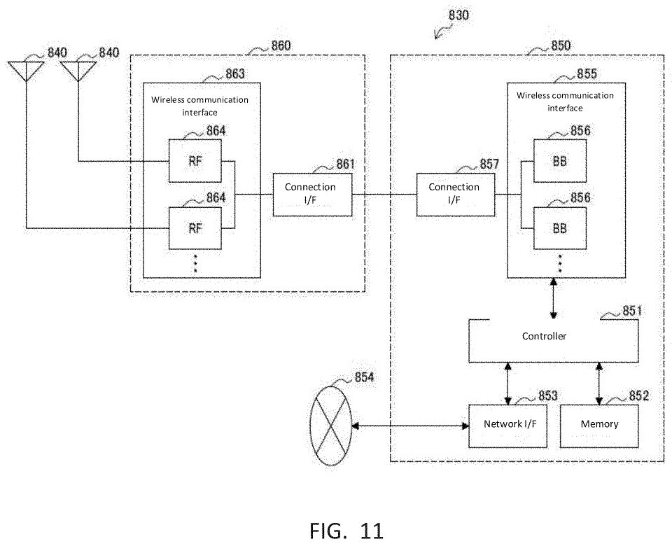

FIG. 11 is a block diagram illustrating a second example of a schematic configuration of an MNO device to which the technology of the present disclosure may be applied. The MNO device may be an electronic device for performing operations of MNO 1100 according to an embodiment of the present disclosure. The electronic device for MNO 1100 is shown as gNB 830. The gNB 830 includes one or more antennas 840, a base station device 850 and a RRH 860. The RRH 860 and each antenna 840 may be connected to each other via an RF cable. The base station device 850 and the RRH 860 may be connected to each other via a high-speed line such as an optical fiber cable.

Each of the antennas 840 includes a single or multiple antenna elements (such as multiple antenna elements included in a MIMO antenna) and is used by the RRH 860 to transmit and receive wireless signals. As shown in FIG. 11, the gNB 830 may include multiple antennas 840. For example, the multiple 840 may be compatible with multiple frequency bands used by the gNB 830. FIG. 11 illustrates an example in which the gNB 830 includes multiple antennas 840 that may be used to implement a multi-carrier system of an embodiment of the present disclosure.

The base station device 850 includes a controller 851, a memory 852, a network interface 853, a wireless communication interface 855, and a connection interface 857. The controller 851, the memory 852 and the network interface 853 are the same as the controller 821, the memory 822 and the network interface 823 described with reference to FIG. 10.

The wireless communication interface 855 supports any cellular communication scheme (such as LTE and LTE-Advanced), and provides wireless communication to a terminal located in a sector corresponding to the RRH 860 via RRH 860 and the antenna 840. The wireless communication interface 855 may generally include, for example, a BB processor 856. The BB processor 856 is the same as the BB processor 826 described with reference to FIG. 10, except that the BB processor 856 is connected to the RF circuit 864 of the RRH 860 via the connection interface 857. As shown in FIG. 11, the wireless communication interface 855 may include multiple BB processors 856. For example, the multiple BB processors 856 may be compatible with multiple frequency bands used by the gNB 830. Although FIG. 11 illustrates an example in which the wireless communication interface 855 includes multiple BB processors 856, the wireless communication interface 855 may also include a single BB processor 856.

The connection interface 857 is an interface for connecting the base station device 850 (wireless communication interface 855) to the RRH 860. The connection interface 857 may also be a communication module for communication in the above high-speed line connecting the base station device 850 (wireless communication interface 855) to the RRH 860.

The RRH 860 includes a connection interface 861 and a wireless communication interface 863.

The connection interface 861 is an interface for connecting the RRH 860 (wireless communication interface 863) to the base station device 850. The connection interface 861 may also be a communication module for communication in the above high-speed line.

The wireless communication interface 863 transmits and receives wireless signals via the antenna 840. The wireless communication interface 863 may generally include, for example, an RF circuit 864. The RF circuit 864 may include, for example, a mixer, a filter, and an amplifier, and transmit and receive wireless signals via the antenna 840. As illustrated in FIG. 11, the wireless communication interface 863 may include multiple RF circuits 864. For example, the multiple RF circuits 864 may support multiple antenna elements. Although FIG. 11 illustrates an exemplary in which the wireless communication interface 863 includes multiple RF circuits 864, the wireless communication interface 863 may also include a single RF circuit 864.

In the gNB 830 shown in FIG. 11, one or more components for performing the functions of the MNO described in this disclosure may be implemented in the wireless communication interface 855. Alternatively, at least a part of these components may be implemented in the controller 851. For example, the gNB 830 includes a portion (for example, the BB processor 856) or the whole of the wireless communication interface 855, and/or a module including the controller 851, and one or more components may be implemented in the module. In this case, the module may store a program for allowing the processor to function as one or more components (in other words, a program for allowing the processor to perform operations of one or more components), and may execute the program. As another example, a program for allowing the processor to function as one or more components may be installed in the gNB 830, and the wireless communication interface 855 (for example, the BB processor 856) and/or the controller 851 may execute the program. As above, as an apparatus including one or more components, a gNB 830, a base station device 850, or a module may be provided, and a program for allowing the processor to function as one or more components may be provided. In addition, a readable medium in which the program is recorded may be provided.

In addition, in the gNB 830 shown in FIG. 11, the communication unit for the electronic device of the MNO may be implemented in the wireless communication interface 855 (e.g., the BB circuit 856). In addition, the communication unit may also be implemented in the controller 851 and/or the network interface 853.

### 7-2. Applicable Examples of User Electronic Device

### First Applicable Example

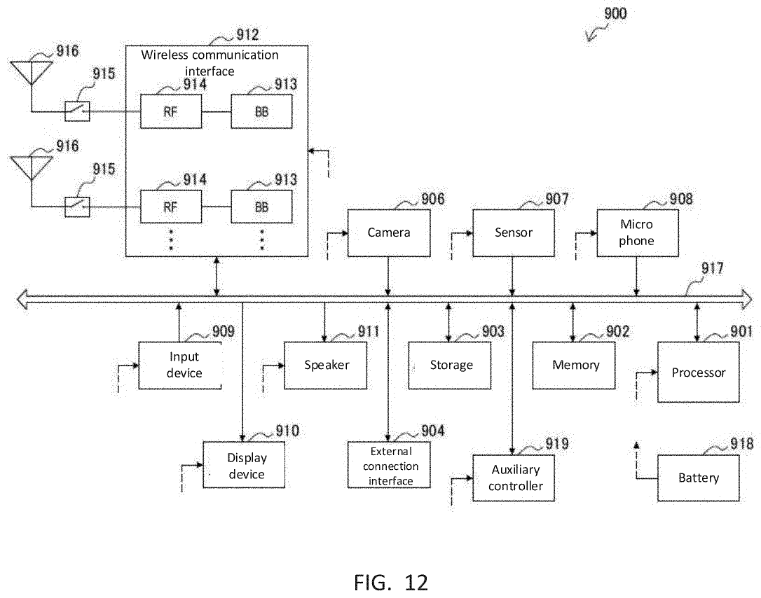

FIG. 12 is a block diagram showing an example of a schematic configuration of a smart phone 900 to which the technology of the present disclosure may be applied. The smart phone 900 may be a user device 1400 according to an embodiment of the present disclosure. The smart phone 900 includes a processor 901, a memory 902, a storage 903, an external connection interface 904, a camera 906, a sensor 907, a microphone 908, an input device 909, a display device 910, a speaker 911, a wireless communication interface 912, one or more antenna switch 915, one or more antennas 916, a bus 917, a battery 918, and an auxiliary controller 919.

The processor 901 may be, for example, a CPU or a system on a chip (SoC), and controls functions of an application layer and other layers of the smart phone 900. The memory 902 includes RAM and ROM, and stores data and programs executed by the processor 901. The storage 903 may include a storage medium such as a semiconductor memory and a hard disk. The external connection interface 904 is an interface for connecting an external device such as a memory card and a universal serial bus (USB) device to the smart phone 900.

The camera 906 includes an image sensor such as a charge coupled device (CCD) and a complementary metal oxide semiconductor (CMOS), and generates a captured image. The sensor 907 may include a group of sensors, such as a measurement sensor, an f-gyro sensor, a geomagnetic sensor, and an acceleration sensor. The microphone 908 converts sounds that are input to the smart phone 900 into audio signals. The input device 909 includes, for example, a touch sensor configured to detect touch on the screen of the display device 910, a keypad, a keyboard, a button, or a switch, and receives an operation or information input from a user. The display device 910 includes a screen such as a liquid crystal display (LCD) and an organic light emitting diode (OLED) display, and displays an output image of the smart phone 900. The speaker 911 converts audio signals that are output from the smart phone 900 into sounds.

The wireless communication interface 912 supports any cellular communication scheme (such as LTE and LTE-Advanced) and performs wireless communication. The wireless communication interface 912 may generally include, for example, a BB processor 913 and an RF circuit 914. The BB processor 913 may perform, for example, encoding/decoding, modulating/demodulating, and multiplexing/demultiplexing, and perform various types of signal processing for wireless communication. Meanwhile, the RF circuit 914 may include, for example, a mixer, a filter, and an amplifier, and transmit and receive wireless signals via the antenna 916. The wireless communication interface 912 may be one chip module on which the BB processor 913 and the RF circuit 914 are integrated. As shown in FIG. 12, the wireless communication interface 912 may include multiple BB processors 913 and multiple RF circuits 914. Although FIG. 12 illustrates an example in which the wireless communication interface 912 includes multiple BB processors 913 and multiple RF circuits 914, the wireless communication interface 912 may also include a single BB processor 913 or a single RF circuit 914.

Furthermore, in addition to the cellular communication scheme, the wireless communication interface 912 may support another type of wireless communication scheme, such as a short-range wireless communication scheme, a near field communication scheme, and a wireless local area network (LAN) scheme. In this case, the wireless communication interface 912 may include a BB processor 913 and an RF circuit 914 for each wireless communication scheme.

Each of the antenna switches 915 switches connection destinations of the antenna 916 among a plurality of circuits (for example, circuits for different wireless communication schemes) included in the wireless communication interface 912.

Each of the antennas 916 includes a single or multiple antenna elements (such as multiple antenna array elements included in a MIMO antenna), and is used for the wireless communication interface 912 to transmit and receive wireless signals. As illustrated in FIG. 12, the smart phone 900 may include multiple antennas 916. Although FIG. 12 illustrates an exemplary in which the smart phone 900 includes multiple antennas 916, the smart phone 900 may also include a single antenna 916.

In addition, the smart phone 900 may include an antenna 916 for each wireless communication scheme. In this case, the antenna switch 915 may be omitted from the configuration of the smart phone 900.

The bus 917 connects the processor 901, the memory 902, the storage 903, the external connection interface 904, the camera 906, the sensor 907, the microphone 908, the input device 909, the display device 910, the speaker 911, the wireless communication interface 912, and the auxiliary controller 919 to each other. The battery 918 supplies power to each block of the smart phone 900 illustrated in FIG. 12 via a feeder line, which is partially illustrated as a dashed line in the figure. The auxiliary controller 919 operates the minimum necessary functions of the smart phone 900 in a sleep mode, for example.

In the smart phone 900 shown in FIG. 12, one or more components for implementing users' operations described in the present disclosure may be implemented in the wireless communication interface 912. Alternatively, at least a part of these components may be implemented in the processor 901 or the auxiliary controller 919. As one example, the smart phone 900 includes a portion (for example, the BB processor 913) or the whole of the wireless communication interface 912, and/or a module including the processor 901 and/or the auxiliary controller 919, and one or more components may be implemented in the module. In this case, the module may store a program that allows processing to function as one or more components (in other words, a program for allowing the processor to perform operations of one or more components), and may execute the program. As another example, a program for allowing the processor to function as one or more components may be installed in the smart phone 900, and the wireless communication interface 912 (for example, the BB processor 913), the processor 901, and/or the auxiliary controller 919 may execute the program. As above, as an apparatus including one or more components, a smart phone 900 or a module may be provided, and a program for allowing the processor to function as one or more components may be provided. In addition, a readable medium in which the program is recorded may be provided.

In addition, in the smartphone 900 shown in FIG. 12, for example, a communication unit for user device may be implemented in the wireless communication interface 912 (e.g., the RF circuit 914).

### Second Applicable Example

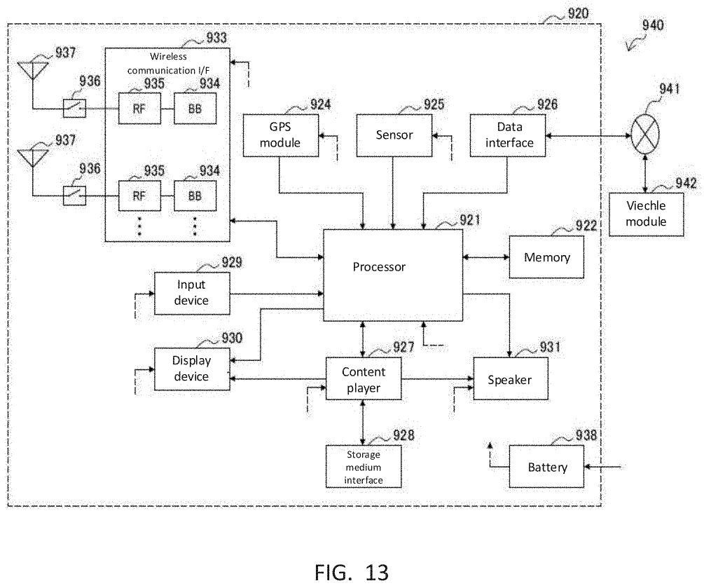

FIG. 13 is a block diagram illustrating an example of a schematic configuration of a car navigation device 920 to which the technology of the present disclosure may be applied. The car navigation device 920 may be a user-side electronic device according to an embodiment of the present disclosure. The car navigation device 920 includes a processor 921, a memory 922, a global positioning system (GPS) module 924, a sensor 925, a data interface 926, a content player 927, a storage medium interface 928, an input device 929, a display device 930, a speaker 931, a wireless communication interface 933, one or more antenna switches 936, one or more antennas 937, and a battery 938.

The processor 921 may be, for example, a CPU or a SoC, and controls the navigation function and other functions of the car navigation device 920. The memory 922 includes RAM and ROM, and stores data and programs executed by the processor 921.

The GPS module 924 measures the location (such as latitude, longitude, and altitude) of the car navigation device 920 using GPS signals received from GPS satellites. The sensor 925 may include a group of sensors, such as a gyro sensor, a geomagnetic sensor, and a barometric sensor. The data interface 926 is connected to, for example, an in-vehicle network 941 via a terminal that is not shown, and acquires data (such as vehicle speed data) generated by the vehicle.

The content player 927 reproduces content stored in a storage medium (such as CD and DVD) that is inserted into the storage medium interface 928. The input device 929 includes, for example, a touch sensor configured to detect touch on the screen of the display device 930, a button, or a switch, and receives an operation or information input from a user. The display device 930 includes a screen such as an LCD or an OLED display, and displays images of navigation functions or reproduced content. The speaker 931 outputs sounds of the navigation functions or the reproduced content.

The wireless communication interface 933 supports any cellular communication scheme (such as LTE and LTE-Advanced) and performs wireless communication. The wireless communication interface 933 may generally include, for example, a BB processor 934 and an RF circuit 935. The BB processor 934 may perform, for example, encoding/decoding, modulating/demodulating, and multiplexing/demultiplexing, and perform various types of signal processing for wireless communication. Meanwhile, the RF circuit 935 may include, for example, a mixer, a filter, and an amplifier, and transmit and receive wireless signals via the antenna 937. The wireless communication interface 933 may also be one chip module on which the BB processor 934 and the RF circuit 935 are integrated. As illustrated in FIG. 13, the wireless communication interface 933 may include multiple BB processors 934 and multiple RF circuits 935. Although FIG. 13 illustrates an exemplary in which the wireless communication interface 933 includes multiple BB processors 934 and multiple RF circuits 935, the wireless communication interface 933 may also include a single BB processor 934 or a single RF circuit 935.

Also, in addition to the cellular communication scheme, the wireless communication interface 933 may support another type of wireless communication scheme, such as a short-range wireless communication scheme, a near field communication scheme, and a wireless LAN scheme. In this case, the wireless communication interface 933 may include a BB processor 934 and an RF circuit 935 for each wireless communication scheme.

Each of the antenna switches 936 switches connection destinations of the antenna 937 among a plurality of circuits (such as circuits for different wireless communication schemes) included in the wireless communication interface 933.

Each of the antennas 937 includes a single or multiple antenna elements (such as multiple antenna array elements included in a MIMO antenna), and is used for the wireless communication interface 933 to transmit and receive wireless signals. As illustrated in FIG. 13, the car navigation device 920 may include multiple antennas 937. Although FIG. 13 illustrates an exemplary in which the car navigation device 920 includes multiple antennas 937, the car navigation device 920 may also include a single antenna 937.

In addition, the car navigation device 920 may include an antenna 937 for each wireless communication scheme. In this case, the antenna switch 936 may be omitted from the configuration of the car navigation device 920.

The battery 938 supplies power to each block of the car navigation device 920 illustrated in FIG. 13 via a feeder line that is partially illustrated as a dashed line in the figure. The battery 938 accumulates electric power supplied from the vehicle.

In the car navigation device 920 shown in FIG. 13, one or more components for realizing users' operation described in the present disclosure may be implemented in the wireless communication interface 933. Alternatively, at least a part of these components may be implemented in the processor 921. As one example, the car navigation device 920 includes a portion (for example, the BB processor 934) or the whole of the wireless communication interface 933, and/or a module including the processor 921, and one or more components may be implemented in the module. In this case, the module may store a program that allows processing to function as one or more components (in other words, a program for allowing the processor to perform operations of one or more components), and may execute the program. As another example, a program for allowing the processor to function as one or more components may be installed in the car navigation device 920, and the wireless communication interface 933 (for example, the BB processor 934) and/or the processor 921 may execute the program. As above, as an apparatus including one or more components, a car navigation device 920 or a module may be provided, and a program for allowing the processor to function as one or more components may be provided. In addition, a readable medium in which the program is recorded may be provided.

In addition, in the car navigation device 920 shown in FIG. 13, for example, a communication unit for user electronic device may be implemented in the wireless communication interface 933 (e.g., the RF circuit 935).

The technology of the present disclosure may also be implemented as an in-vehicle system (or vehicle) 940 including one or more blocks in the car navigation device 920, the in-vehicle network 941, and the vehicle module 942. The vehicle module 942 generates vehicle data (such as vehicle speed, engine speed, and failure information), and outputs the generated data to the in-vehicle network 941.

In addition, a readable medium in which the program is recorded may be provided. Therefore, the present disclosure also relates to a computer-readable storage medium on which there is stored a program including instructions, which are used to implement the aforementioned communication method when loaded and executed by a processor such as a processing circuitry or a controller.

The exemplary embodiments of the present disclosure are described above with reference to the accompanying drawings, but the present disclosure is of course not limited to the above examples. A person skilled in the art may obtain various alterations and modifications within the scope of the appended claims, and it should be understood that these alterations and modifications will naturally fall within the technical scope of the present disclosure.

It should be understood that the machine-executable instructions in the machine-readable storage medium or the program product according to the embodiments of the present disclosure may be configured to perform operations corresponding to the above device and method embodiments. When referring to the above device and method embodiments, the embodiments of the machine-readable storage medium or the program product will be obvious to those skilled in the art, so the description thereof will not be repeated. Machine-readable storage media and program products for carrying or including the above machine-executable instructions also fall within the scope of the present disclosure. Such storage media may include, but are not limited to, floppy disks, optical disks, magneto-optical disks, memory cards, memory sticks, and the like.

In addition, it should be understood that the series of processes and devices described above may also be implemented by software and/or firmware. In a case where they are implemented by software and/or firmware, respective programs constituting respective software are stored in the storage medium of related devices, which, when executed, may perform various functions.

For example, a plurality of functions included in one unit in the above embodiments may be realized by separate devices. Alternatively, a plurality of functions implemented by a plurality of units in the above embodiments may be implemented by separate devices respectively. In addition, one of the above functions may be realized by a plurality of units. Needless to say, such configurations are included in the technical scope of the present disclosure.

In this specification, the steps described in the flowcharts include not only processes performed in time series in the stated order but also processes performed in parallel or individually and not necessarily in time series. Furthermore, even in the steps processed in time-series, needless to say, the order may be appropriately changed.

Additionally, the methods and systems of the present invention may be implemented in a variety of ways. For example, the methods and systems of the present invention may be implemented by software, hardware, firmware, or any combination thereof. The sequence of steps of the methods described above is illustrative only, and unless specifically stated otherwise, the steps of the methods of the present invention are not limited to the sequence specifically described above. Furthermore, in some embodiments, the present invention may also be embodied as a program recorded in a recording medium, including machine-readable instructions for implementing the methods according to the present invention. Therefore, the present invention also covers a recording medium storing a program for implementing the method according to the present invention. Such storage media may include, but are not limited to, floppy disks, optical disks, magneto-optical disks, memory cards, memory sticks, and the like.

Those skilled in the art will appreciate that the boundaries between the above operations are merely illustrative. Multiple operations may be combined into a single operation, a single operation may be distributed among additional operations, and operations may be performed with at least partial overlap in time. Also, alternative embodiments may include multiple instances of a particular operation, and the order of operations may be altered in other various embodiments. However, other modifications, changes and substitutions are also possible. Accordingly, the specification and drawings are to be regarded as illustrative rather than restrictive.

In addition, the embodiments of the present disclosure may further include the following Exemplary Examples (EEs).
EE1. A blockchain node for facilitating spectrum sharing, the blockchain node being included in a blockchain network that is communicatively connected to service providers and mobile network operators associated with wireless network services, the blockchain node including a processing circuit, wherein the processing circuit is configured to: determine a spectrum price for a spectrum transaction between a service provider and a mobile network operator based on performance functions of the service provider and the mobile network operator; and record spectrum transaction information that is based on the spectrum price in a blockchain, including: verifying back-block data of a block that is generated by a leader node of the blockchain network, the block recording the spectrum transaction information that is based on the spectrum price, and the back-block data only including a portion of the block; and in response to the back-block data passing the verification, adding the block that is generated by the leader node to the blockchain.
EE2. The blockchain node of EE1, wherein the processing circuit is configured to determine the spectrum price based on the performance functions by the following operations: receiving spectrum demand information of the service provider; receiving spectrum quotation information of the mobile network operator; calculating performance of the service provider or the mobile network operator using the performance functions based on the spectrum demand information and the spectrum quotation information; determining whether the performance satisfies a Nash equilibrium condition that is based on a Stackelberg gaming process; and determining the spectrum price for the spectrum transaction in response to the performance satisfying the Nash equilibrium condition.
EE3. The blockchain node of EE2, wherein the processing circuit is further configured to: in response to the performance not satisfying the Nash equilibrium condition, receive updated spectrum demand information of the service provider and updated spectrum quotation information of the mobile network operator; and calculate updated performance of the service provider or the mobile network operator based on the updated spectrum demand information and the updated spectrum quotation information.
EE4. The blockchain node of EE1, wherein the processing circuit is configured to calculate a performance function of the service provider based at least on income of the service provider, the income of the service provider including at least one of: a first compensation income, which is obtained by the service provider in response to a detection that the service provider did not obtain a spectrum and from a second service provider that obtained the spectrum; or a second compensation income, which is obtained by the service provider from the second service provider in response to a detection that the second service provider refused to pay the first compensation income.
EE5S. The blockchain node of EE4, wherein the processing circuit is configured to calculate the performance function of the service provider by at least the following operations: receiving one or more compensation coefficients from the service provider; and determining the first compensation income or the second compensation income based on the one or more compensation coefficients.
EE6. The blockchain node of EE1, wherein the processing circuit is configured to calculate a performance function of the service provider based at least on a payout of the service provider, the payout of the service provider including at least one of: a first compensation payout, which is paid by the service provider to one or more other service providers that did not obtain a spectrum in response to a detection that the service provider obtained the spectrum; or a second compensation payout, which is paid by the service provider to the one or more other service providers in response to a detection that the service provider did not paid the first compensation payout.
EE7. The blockchain node according to EE1, wherein the leader node is selected as a node that generates a block earliest among all nodes of the blockchain network.
EE8. The blockchain node according to EE7, wherein generating a block comprises finding a random number that satisfies an operation threshold condition based on a hash operation, wherein the operation threshold condition for each node is determined based on a coin age of the node.
EE9. The blockchain node according to EE1, wherein the processing circuit of the blockchain node is further configured to: in response to the back-block data of the leader node failing to pass the verification, verify back-block data of a block that is generated by a candidate node of the blockchain network, wherein the candidate node is a node in the blockchain network that satisfies the following conditions: a difference between the time when the candidate node generates the block and the time when the leader node generates the block does not exceed a predetermined time threshold, and a coin age of the candidate node is less than a coin age of the leader node.
EE10. The blockchain node according to EE9, wherein the processing circuit of the blockchain node is further configured to: in response to the back-block data of the candidate node passing the verification, add the block generated by the candidate node to the blockchain; and in response to the back-block data of the candidate node failing to pass the verification, terminate to record the spectrum transaction information in the blockchain.
EE11. The blockchain node according to EE8, wherein the back-block data includes the spectrum price and the random number satisfying the operation threshold condition but does not include identity information of traders of the spectrum transaction.
EE12. A method for facilitating spectrum sharing, wherein the method comprising performing the following operations by a blockchain node in a blockchain network communicatively connected to service providers and mobile network operators associated with wireless network services: determining a spectrum price for a spectrum transaction between a service provider and a mobile network operator based on performance functions of the service provider and the mobile network operator; and recording spectrum transaction information that is based on the spectrum price in a blockchain, including: verifying back-block data of a block that is generated by a leader node of the blockchain network, the block recording the spectrum transaction information that is based on the spectrum price, the back-block data only including a portion of the block; and in response to the back-block data passing the verification, adding the block that is generated by the leader node to the blockchain.
EE13. The method of EE12, wherein determining the spectrum price based on the performance functions comprises: receiving spectrum demand information of the service provider; receiving spectrum quotation information of the mobile network operator; calculating performance of the service provider or the mobile network operator using the performance functions based on the spectrum demand information and the spectrum quotation information; determining whether the performance satisfies a Nash equilibrium condition that is based on a Stackelberg gaming process; and determining the spectrum price for the spectrum transaction in response to the performance satisfying the Nash equilibrium condition.
EE14. The method of EE13, wherein the method further comprises: in response to the performance not satisfying the Nash equilibrium condition, receiving updated spectrum demand information of the service provider and updated spectrum quotation information of the mobile network operator; and calculating updated performance of the service provider or the mobile network operator based on the updated spectrum demand information and the updated spectrum quotation information.
EE15. The method of EE12, wherein the method further comprises calculating a performance function of the service provider based at least on income of the service provider, the income of the service provider including at least one of: a first compensation income, which is obtained by the service provider in response to a detection that the service provider did not obtain a spectrum and from a second service provider that obtained the spectrum; or a second compensation income, which is obtained by the service provider from the second service provider in response to a detection that the second service provider refused to pay the first compensation income.
EE16. The method of EE15, wherein calculating the performance function of the service provider comprises: receiving one or more compensation coefficients from the service provider; and determining the first compensation income or the second compensation income based on the one or more compensation coefficients.
EE17. The method of EE12, wherein the method comprises calculating a performance function of the service provider based at least on a payout of the service provider, the payout of the service provider including at least one of: a first compensation payout, which is paid by the service provider to one or more other service providers that did not obtain a spectrum in response to a detection that the service provider obtained the spectrum; or a second compensation payout, which is paid by the service provider to the one or more other service providers in response to a detection that the service provider did not paid the first compensation payout.
EE18. The method of EE12, wherein the leader node is selected as a node that generates a block earliest among all nodes in the blockchain network.
EE19. The method of EE18, wherein generating a block comprises finding a random number that satisfies an operation threshold condition based on a hash operation, wherein the operation threshold condition for each node is determined based on a coin age of the node.
EE20. The method of EE19, wherein the method further comprises: in response to the back-block data of the leader node failing to pass the verification, verifying back-block data of a block that is generated by a candidate node of the blockchain network, wherein the candidate node is a node in the blockchain network that satisfies the following conditions: a difference between the time when the candidate node generates the block and the time when the leader node generates the block does not exceed a predetermined time threshold, and a coin age of the candidate node is less than a coin age of the leader node.
EE21. The method of EE20, wherein the method further comprises: in response to the back-block data of the candidate node passing the verification, adding the block generated by the candidate node to the blockchain; and in response to the back-block data of the candidate node failing to pass the verification, terminating to record the spectrum transaction information in the blockchain.
EE22. The method according to EE19, wherein the back-block data includes the spectrum price and the random number satisfying the operation threshold condition but does not include identity information of traders of the spectrum transaction.
EE23. An electronic device, wherein the electronic device comprises: at least one processor; and at least one storage device having instructions stored thereon that, when executed by the at least one processor, cause the at least one processor to perform the method of any of EE12-EE22.
EE24. A non-transitory computer-readable storage medium having executable instructions stored thereon that, when executed by a processor, cause the processor to perform the method of any of EE12-EE22.
EE25. A computer program product comprising executable instructions that, when executed by a processor, cause the processor to perform the method of any of EE12-EE22.

Although the present disclosure and the advantages have been described in detail, it should be understood that various changes, substitutions and alterations may be made hereto without departing from the spirit and scope of the disclosure as defined by the appended claims. Moreover, the terms “comprise”, “include” or any other variation thereof in the embodiments of the present disclosure are intended to cover a non-exclusive inclusion such that a process, method, article, or device comprising a series of elements comprises not only those elements, but also other elements not expressly listed, or also comprising elements inherent in such process, method, article or device. Without further limitations, an element defined by the phrase “comprising a . . . ” does not exclude the presence of additional identical elements in the process, method, article or device comprising said element.

Although some specific embodiments of the present disclosure have been described in detail, those skilled in the art should understand that the above embodiments are only illustrative and do not limit the scope of the present disclosure. It should be understood by those skilled in the art that the above embodiments may be combined, modified or replaced without departing from the scope and spirit of the present disclosure. The scope of the present disclosure is defined by the appended claims.

1. A blockchain node for facilitating spectrum sharing, the blockchain node being included in a blockchain network that is communicatively connected to service providers and mobile network operators associated with wireless network services, the blockchain node including a processing circuit, wherein the processing circuit is configured to:
determine a spectrum price for a spectrum transaction between a service provider and a mobile network operator based on performance functions of the service provider and the mobile network operator; and
record spectrum transaction information that is based on the spectrum price in a blockchain, including:
verifying back-block data of a block that is generated by a leader node of the blockchain network, the block recording the spectrum transaction information that is based on the spectrum price, and the back-block data only including a portion of the block; and
in response to the back-block data passing the verification, adding the block that is generated by the leader node to the blockchain.

2. The blockchain node of claim 1, wherein the processing circuit is configured to determine the spectrum price based on the performance functions by the following operations:
receiving spectrum demand information of the service provider;
receiving spectrum quotation information of the mobile network operator;
calculating performance of the service provider or the mobile network operator using the performance functions based on the spectrum demand information and the spectrum quotation information;
determining whether the performance satisfies a Nash equilibrium condition that is based on a Stackelberg gaming process; and
determining the spectrum price for the spectrum transaction in response to the performance satisfying the Nash equilibrium condition.

3. The blockchain node of claim 2, wherein the processing circuit is further configured to:
in response to the performance not satisfying the Nash equilibrium condition, receive updated spectrum demand information of the service provider and updated spectrum quotation information of the mobile network operator; and
calculate updated performance of the service provider or the mobile network operator based on the updated spectrum demand information and the updated spectrum quotation information.

4. The blockchain node of claim 1, wherein the processing circuit is configured to calculate a performance function of the service provider based at least on income of the service provider, the income of the service provider including at least one of:
a first compensation income, which is obtained by the service provider in response to a detection that the service provider did not obtain a spectrum and from a second service provider that obtained the spectrum; or
a second compensation income, which is obtained by the service provider from the second service provider in response to a detection that the second service provider refused to pay the first compensation income.

5. The blockchain node of claim 4, wherein the processing circuit is configured to calculate the performance function of the service provider by at least the following operations:
receiving one or more compensation coefficients from the service provider; and
determining the first compensation income or the second compensation income based on the one or more compensation coefficients.

6. The blockchain node of claim 1, wherein the processing circuit is configured to calculate a performance function of the service provider based at least on a payout of the service provider, the payout of the service provider including at least one of:
a first compensation payout, which is paid by the service provider to one or more other service providers that did not obtain a spectrum in response to a detection that the service provider obtained the spectrum; or
a second compensation payout, which is paid by the service provider to the one or more other service providers in response to a detection that the service provider did not paid the first compensation payout.

7. The blockchain node according to claim 1, wherein the leader node is selected as a node that generates a block earliest among all nodes of the blockchain network.

8. The blockchain node according to claim 7, wherein generating a block comprises finding a random number that satisfies an operation threshold condition based on a hash operation, wherein the operation threshold condition for each node is determined based on a coin age of the node.

9. The blockchain node according to claim 1, wherein the processing circuit of the blockchain node is further configured to:
in response to the back-block data of the leader node failing to pass the verification, verify back-block data of a block that is generated by a candidate node of the blockchain network,
wherein the candidate node is a node in the blockchain network that satisfies the following conditions: a difference between the time when the candidate node generates the block and the time when the leader node generates the block does not exceed a predetermined time threshold, and a coin age of the candidate node is less than a coin age of the leader node.

10. The blockchain node according to claim 9, wherein the processing circuit of the blockchain node is further configured to:
in response to the back-block data of the candidate node passing the verification, add the block generated by the candidate node to the blockchain; and
in response to the back-block data of the candidate node failing to pass the verification, terminate to record the spectrum transaction information in the blockchain.

11. The blockchain node according to claim 8, wherein the back-block data includes the spectrum price and the random number satisfying the operation threshold condition but does not include identity information of traders of the spectrum transaction.

12. A method for facilitating spectrum sharing, wherein the method comprising performing the following operations by a blockchain node in a blockchain network communicatively connected to service providers and mobile network operators associated with wireless network services:
determining a spectrum price for a spectrum transaction between a service provider and a mobile network operator based on performance functions of the service provider and the mobile network operator; and
recording spectrum transaction information that is based on the spectrum price in a blockchain, including:
verifying back-block data of a block that is generated by a leader node of the blockchain network, the block recording the spectrum transaction information that is based on the spectrum price, the back-block data only including a portion of the block; and
in response to the back-block data passing the verification, adding the block that is generated by the leader node to the blockchain.

13. The method of claim 12, wherein determining the spectrum price based on the performance functions comprises:
receiving spectrum demand information of the service provider;
receiving spectrum quotation information of the mobile network operator;
calculating performance of the service provider or the mobile network operator using the performance functions based on the spectrum demand information and the spectrum quotation information;
determining whether the performance satisfies a Nash equilibrium condition that is based on a Stackelberg gaming process; and
determining the spectrum price for the spectrum transaction in response to the performance satisfying the Nash equilibrium condition.

14. The method of claim 13, wherein the method further comprises:
in response to the performance not satisfying the Nash equilibrium condition, receiving updated spectrum demand information of the service provider and updated spectrum quotation information of the mobile network operator; and
calculating updated performance of the service provider or the mobile network operator based on the updated spectrum demand information and the updated spectrum quotation information.

15. The method of claim 12, wherein the method further comprises calculating a performance function of the service provider based at least on income of the service provider, the income of the service provider including at least one of:
a first compensation income, which is obtained by the service provider in response to a detection that the service provider did not obtain a spectrum and from a second service provider that obtained the spectrum; or
a second compensation income, which is obtained by the service provider from the second service provider in response to a detection that the second service provider refused to pay the first compensation income.

16. The method of claim 15, wherein calculating the performance function of the service provider comprises:
receiving one or more compensation coefficients from the service provider; and
determining the first compensation income or the second compensation income based on the one or more compensation coefficients.

17. The method of claim 12, wherein the method comprises calculating a performance function of the service provider based at least on a payout of the service provider, the payout of the service provider including at least one of:
a first compensation payout, which is paid by the service provider to one or more other service providers that did not obtain a spectrum in response to a detection that the service provider obtained the spectrum; or
a second compensation payout, which is paid by the service provider to the one or more other service providers in response to a detection that the service provider did not paid the first compensation payout.

18. The method of claim 12, wherein the leader node is selected as a node that generates a block earliest among all nodes in the blockchain network.

19. The method of claim 18, wherein generating a block comprises finding a random number that satisfies an operation threshold condition based on a hash operation, wherein the operation threshold condition for each node is determined based on a coin age of the node.

20. The method of claim 19, wherein the method further comprises:
in response to the back-block data of the leader node failing to pass the verification, verifying back-block data of a block that is generated by a candidate node of the blockchain network,
wherein the candidate node is a node in the blockchain network that satisfies the following conditions: a difference between the time when the candidate node generates the block and the time when the leader node generates the block does not exceed a predetermined time threshold, and a coin age of the candidate node is less than a coin age of the leader node;
wherein the method further comprises:
in response to the back-block data of the candidate node passing the verification, adding the block generated by the candidate node to the blockchain; and
in response to the back-block data of the candidate node failing to pass the verification, terminating to record the spectrum transaction information in the blockchain;
wherein the back-block data includes the spectrum price and the random number satisfying the operation threshold condition but does not include identity information of traders of the spectrum transaction.

21.-25. (canceled)
